(19) United States
(12) Patent Application Publication
(10) Pub. No.: US 2021/0090328 A1
(43) Pub. Date: Mar. 25, 2021

(54) TILE-BASED SPARSITY AWARE DATAFLOW OPTIMIZATION FOR SPARSE DATA

(71) Applicant: Intel Corporation, Santa Clara, CA (US)

(72) Inventors: Prashant Laddha, Bengaluru (IN); Anirud Thyagharajan, Bengaluru (IN); Om Ji Omer, Bangalore (IN); Sreenivas Subramoney, Bangalore (IN)

(21) Appl. No.: 17/114,315

(22) Filed: Dec. 7, 2020

(51) Int. Cl. G06T 17/05; G06T 7/70; G06N 3/04; G06F 16/31

(52) U.S. Cl. CPC G06T 17/05; G06T 7/70; G06N 3/0454; G06T 2207/20081; G06T 2207/10028; G06T 2207/20084; G06F 16/31

(57) ABSTRACT

Systems, apparatuses and methods provide technology for optimizing processing of sparse data, such as 3D pointcloud data sets. The technology may include generating a locality-aware rulebook based on an input unstructured sparse data set, such as a 3D pointcloud data set, the locality-aware rulebook storing spatial neighborhood information for active voxels in the input unstructured sparse data set, computing an average receptive field (ARF) value based on the locality aware rulebook, and determining, from a plurality of tile size and loop order combinations, a tile size and loop order combination for processing the unstructured sparse data based on the computed ARF value. The technology may also include providing the locality-aware rulebook and the tile size and loop order combination to a compute engine such as a neural network, the compute engine to process the unstructured sparse data using the locality aware rulebook and the tile size and loop order combination.

### TECHNICAL FIELD

Embodiments generally relate to computing systems. More particularly, embodiments relate to improving performance in processing unstructured sparse data, such as three-dimensional (3D) pointcloud data, using tile-based execution and sparsity-aware dataflow optimization.

### BACKGROUND

Understanding three-dimensional (3D) geometry and semantics of a scene are essential to many real-world systems such as autonomous driving, robotics, remote sensing, augmented reality/virtual reality (AR/VR) systems, and so forth. Conventional solutions may face a number of challenges in processing 3D visual data.

### BRIEF DESCRIPTION OF THE DRAWINGS

The various advantages of the embodiments will become apparent to one skilled in the art by reading the following specification and appended claims, and by referencing the following drawings, in which:

FIG. 1 provides a block diagram illustrating an example system for optimizing 3D pointcloud data processing according to one or more embodiments;

FIGS. 2A-2C provide diagrams illustrating aspects of example locality-aware rulebooks according to one or more embodiments;

FIG. 3 provides a diagram illustrating aspects of an example of tiling in optimizing 3D pointcloud data processing according to one or more embodiments;

FIGS. 4A-4B provide diagrams illustrating aspects of example data sparsity attributes according to one or more embodiments;

FIG. 5 provides a flow chart illustrating an example process for optimizing 3D pointcloud data processing dataflow according to one or more embodiments;

FIG. 6 provides a block diagram illustrating an example system for optimizing 3D pointcloud data processing according to one or more embodiments;

FIGS. 7A-7B provide flow charts illustrating example processes for optimizing 3D pointcloud data processing according to one or more embodiments;

FIG. 8 is a block diagram illustrating an example system for optimizing 3D pointcloud data processing according to one or more embodiments;

FIG. 9 is a block diagram illustrating an example semiconductor apparatus for optimizing 3D pointcloud data processing according to one or more embodiments;

FIG. 10 is a block diagram illustrating an example processor according to one or more embodiments; and

FIG. 11 is a block diagram illustrating an example of a multiprocessor-based computing system according to one or more embodiments.

### DESCRIPTION OF EMBODIMENTS

Data from 3D sensors or other 3D data sources is known as 3D pointcloud data (or “pointcloud data”), which is characterized by a high volume but sparse data set. In sparse data sets, much of the data has a value of zero (or near zero), also known as inactive data points. Deep neural network (DNN) methodologies such as, e.g., convolutional neural network (CNN) technology used in two-dimensional (2D) image processing may be considered for various 3D visual and artificial intelligence (AI) applications such as shape classification, object detection, tracking, and scene segmentation. Among several methods proposed for processing 3D data, volumetric projection-based methods may process the neighborhood structure of 3D scenes. These methods face severe challenges, however, in processing 3D visual data due to the high dimensionality and the unstructured nature of 3D data. The volumetric methods involve voxelization which introduces discretization artifacts and causes information loss. Low-resolution voxel representation can degrade accuracy. On the other hand, maintaining high resolution, such as provided for in high-resolution pointclouds, increases computation and memory requirements in cubic order.

Implementations of 3D sparse convolution have drawbacks as well. For example, CPU- and GPU-based implementations involve data movement in gather and scatter operations, which significantly adds to overall execution time. Due to feature-map size for an entire pointcloud exceeding the capacity of inner level of caches, gather and scatter operations require massive data movements across the last-level cache and off-chip memory. In addition, these solutions implement weight stationary (WS), a fixed dataflow for all layers in a neural network, by fetching the weight data only once and having multiple re-fetches for input feature maps (IFMs) and output feature maps (OFMs). Thus, for layers (e.g., initial and last layers in networks) operating over high resolution 3D pointcloud data, a WS dataflow results in excessively high data accesses as feature map size is significantly higher than weight data size. Since execution time is dominated by these layers, adopting a fixed WS dataflow severely degrades overall performance.

Although tiling may have been used in other applications processing dense 2D/3D data, tiling in 3D spatially sparse data (inherent in 3D pointcloud data) would result in extremely inefficient execution due to excessive memory consumption and uneven work distribution as a result of inherent spatial sparsity present in 3D pointcloud data. Furthermore, in the case of 3D spatially sparse CNNs, which store spatially sparse data in 1D compressed data structures, tiling a one-dimensional (1D) compressed structure would also have several challenges. For example, because the size of a compressed data-structure varies per input pointcloud and across different regions within a pointcloud, a tile size requirement may vary significantly and cannot be estimated through mathematical formulation. In addition, storing 3D data in an unordered 1-D compressed format would result in irregular data accesses as convolution operations need to be performed on spatially proximate points in 3D space. Accordingly, data accesses cannot be predicted analytically.

An improved computing system as described herein provides technology to optimize (e.g., accelerate) processing of unstructured sparse data, such as 3D pointcloud data, by a compute engine (which may include a neural network such as a convolution neural network (CNN)) through tile-based execution while orchestrating optimal dataflow for the data processing with input-dependent spatial sparsity. The technology may include generation of a locality-aware rulebook, which encodes the receptive/response field for every voxel in the pointcloud; generation of sparsity attributes to represent the sparsity dependent variation in data accesses and number of operations in spatial regions in the pointcloud data; tiling selection based on 1D compressed pointcloud data; and a sparsity aware dataflow optimization to choose optimal tiling and loop order for each network layer given architecture parameters (e.g., size of available memory or cache). The technology may provide a rulebook structure to enable maximum spatial reuse of data by performing convolution operations over all voxels in the receptive (or response field) with a single fetch of feature map data.

The technology may also include dividing the process of dataflow optimization into an offline stage and a runtime stage to take advantage of meta-sparsity attributes, which are mostly consistent across pointclouds and thus may be extracted in an offline stage by processing a representative set of sample pointclouds. The technology may provide for optimizing dataflow in an offline stage based on the representative set of sample pointclouds, generating a table of optimal tiling and loop orders for each network layer with a table index based on an average receptive field (ARF) value for each sample pointcloud data set. The technology may further provide for determining, in a runtime stage, an optimal tiling and loop order for an input pointcloud data set through a table look-up based on an ARF value computed for the input pointcloud.

Thus, the technology described herein provides a system and method for three-dimensional (3D) sparse convolution, which avoids cubic growth in compute and memory requirements of other solutions. The technology exploits the inherent spatial sparsity present in 3D scenes to provide more efficient execution and storage by storing 3D sparse data in a one-dimensional (1D) compressed data structure and avoiding computation on free (empty) space.

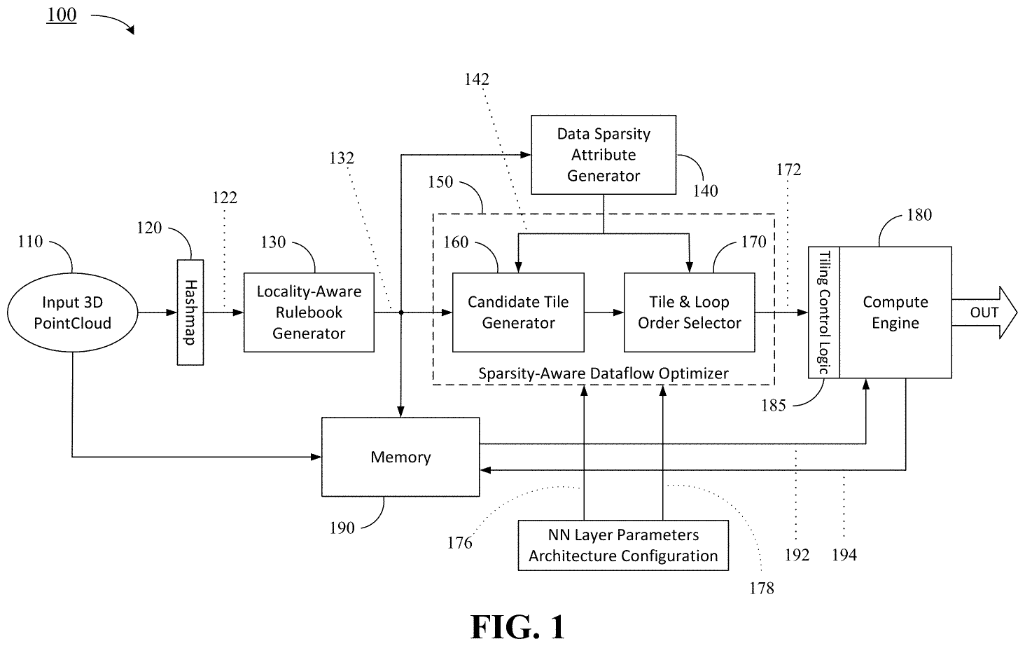

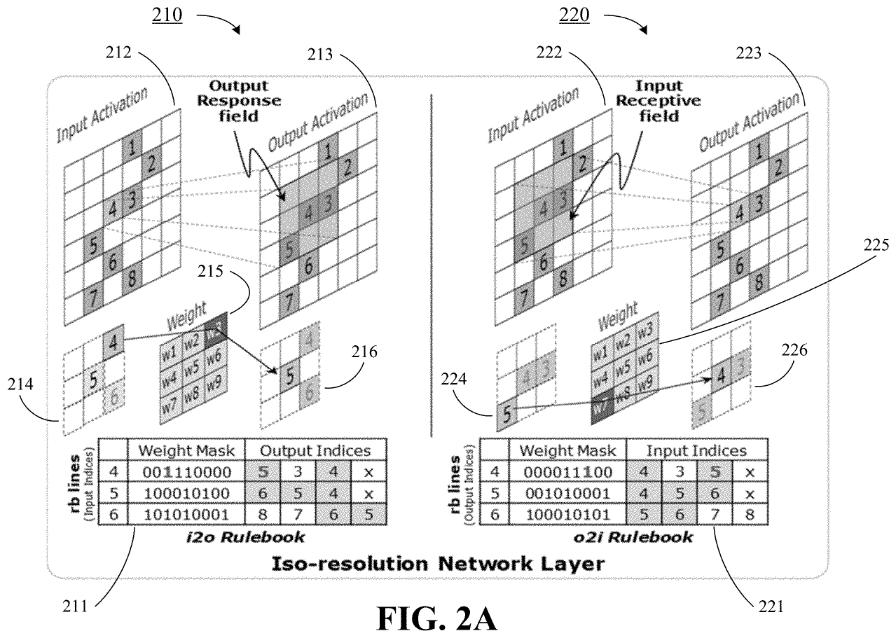

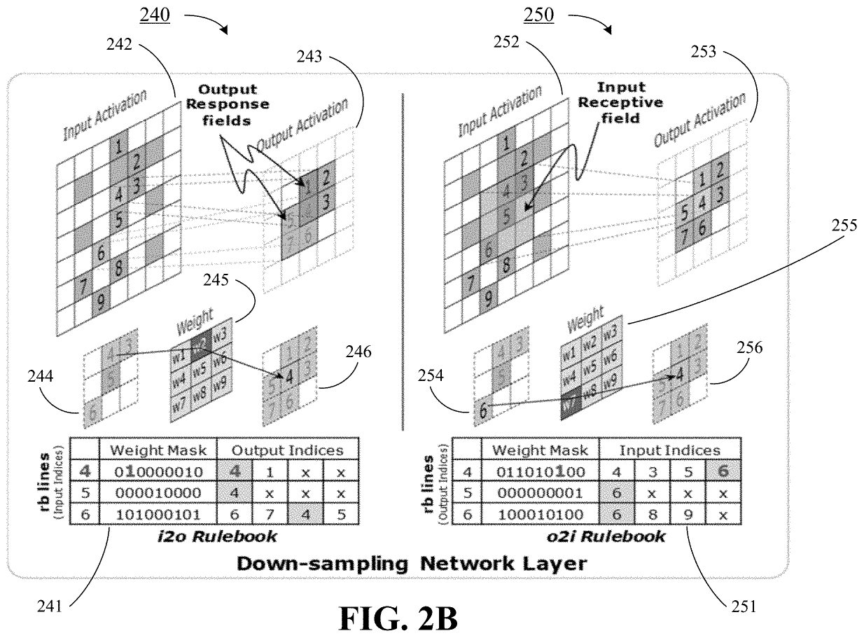

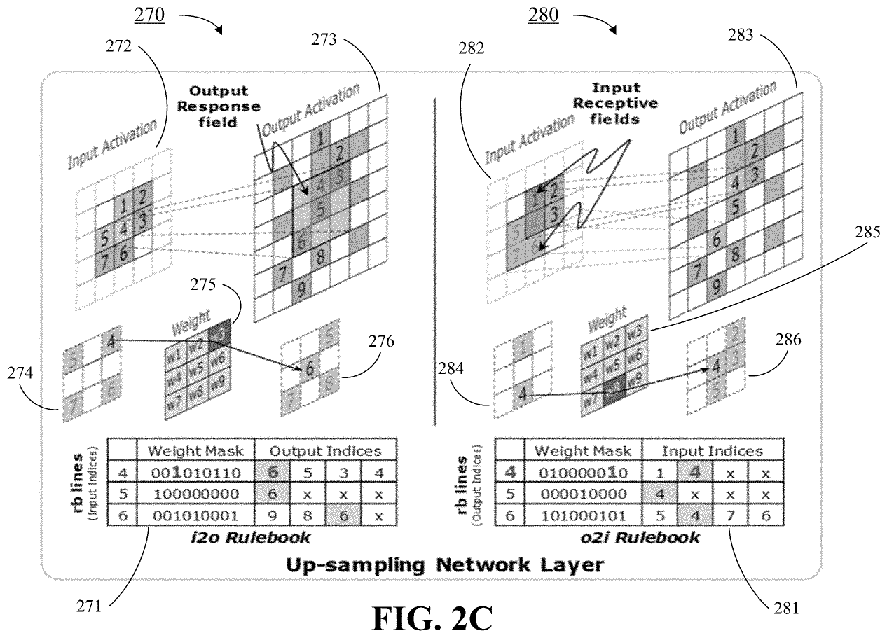

FIG. 1 shows a block diagram of an example system 100 for optimizing 3D pointcloud data processing according to one or more embodiments, with reference to components and features described herein including but not limited to the figures and associated description. The system 100 may process one or more input 3D pointcloud data sets 110 which are each a sparse data set. The system 100 may include applying a hashmap 120 to the input 3D pointcloud data set 110, which applies a spatial hash to map 3D voxel coordinates to generate a set of one-dimensional (1D) compressed data 122. The 1D compressed data set 122 is a structure that captures the coordinates of active voxels in the 3D pointcloud data set. More particularly, the data set 122 is a hashtable which stores a 1D index for each 3D coordinate as a key, value pair. The 3D coordinate of the point is the key and the index is the value. Any suitable hash function that maps 3D coordinates (x,y,z) to a 1D location index (n) may be used. A locality-aware rulebook generator 130 may generate one or more rulebooks 132 based on the 1D compressed data set 122. The locality-aware rulebook generator 130 may provide a metadata structure that stores spatial neighborhood information between input/output voxels for the input 3D pointcloud data set 110 by encoding the active receptive/response fields at each location, and is described further herein and with reference to FIGS. 2A-2C. In some embodiments, the locality-aware rulebook generator 130 may generate one or more rulebooks based on the input 3D pointcloud data set, such that the hashmap function 120 is not utilized.

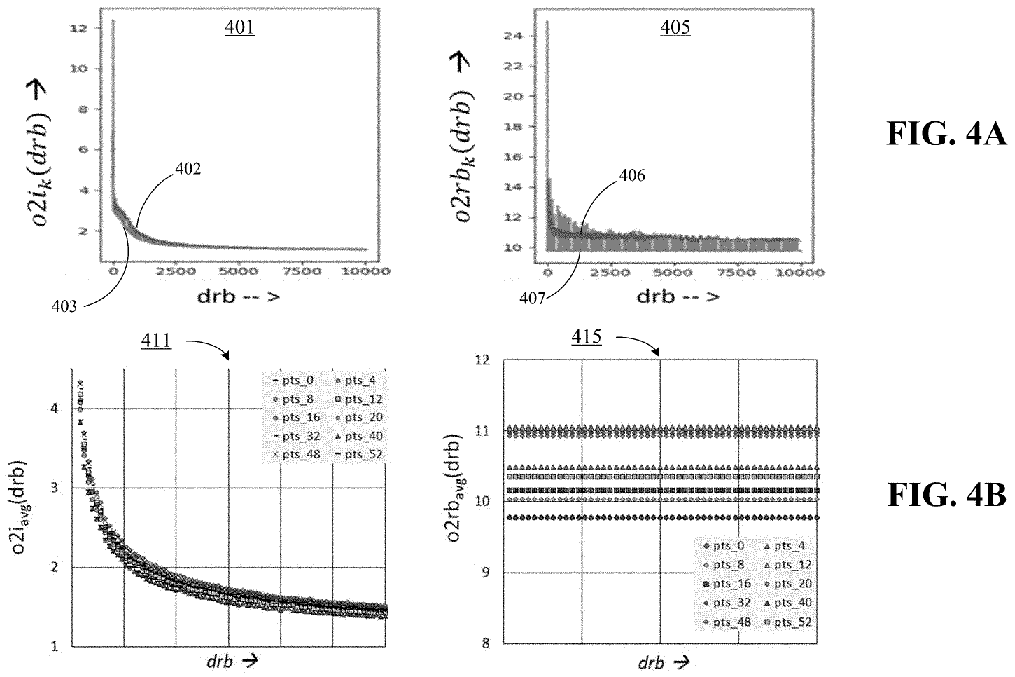

The system 100 may also include a data sparsity attribute generator 140 that processes the locality-aware rulebook(s) 132 and generates a set of data sparsity attributes 142 representing the sparsity of active data (i.e., active voxels) in the input 3D pointcloud data set 110. The data sparsity attributes 142 are further described herein and with reference to FIG. 4A.

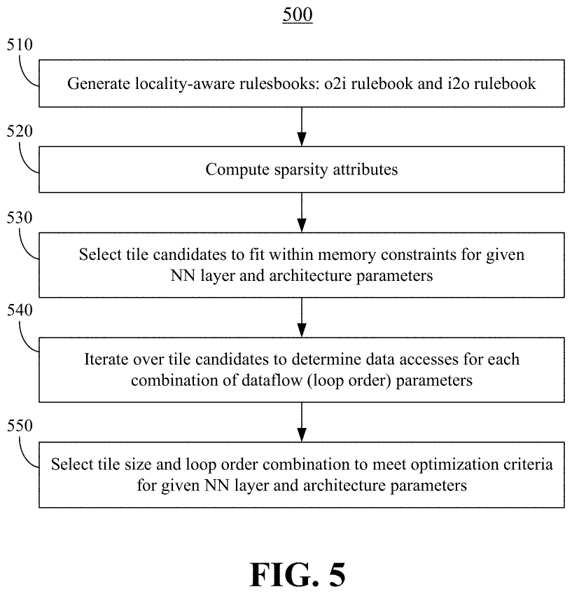

The system 100 may also include a sparsity-aware dataflow optimizer 150, which processes the locality-aware rulebook(s) 132 and the data sparsity attributes 142 to determine a tile size (e.g., an optimal tile size) and loop order for processing the input 3D pointcloud data set 110. The sparsity-aware dataflow optimizer 150 may include a candidate tile generator 160 to generate candidate tile sizes and a tile and loop order selector 170 to select the optimal tile size and loop order 172 based on one or more optimization criteria for the compute engine 180 to process the input 3D pointcloud data set 110. Network and architecture configuration parameters for the compute engine 180, such as neural network (NN) layer parameters 176 and architecture configuration parameters 178, may also be provided to dataflow optimizer 150. NN layer parameters 176 may include the number of input channels, the number of output channels, the number of filter (kernel) parameters, etc. Architecture configuration parameters 178 may include the available memory capacity (e.g., on-chip or cache memory), etc. Further details regarding the sparsity-aware dataflow optimizer 150 are described herein with reference to the sparsity-aware optimal dataflow and process 500 (as described herein with reference to FIG. 5).

The compute engine 180 may implement a neural network such as, e.g., a convolution neural network (CNN), including a 3D CNN, to perform tile-based execution for processing spatially-sparse 3D pointcloud data, and may include tiling control logic 185 to handle selecting input pointcloud data for processing per the selected optimal tile size and loop order 172. The memory 190 may store all or portions of the input feature data associated with each 3D point in the 3D pointcloud data set 110, as well as the locality-aware rulebook(s) 132. The compute engine 180 may fetch data 192, which may include input feature data, network weight data, partially computed output feature data from previous compute steps along with locality-aware rulebook data, from the memory 190 for processing in accordance with the selected optimal tile size and loop order 172. The compute engine may store in memory 190 the intermediate results 194 from processing the pointcloud data (e.g. on a tile or level basis), which may be used in subsequent data fetches for other levels, tiles, etc. Once all processing is competed for the input 3D pointcloud data set 110, the compute engine may provide an output (e.g., data classification or other result).

Some or all components in the system 100 may be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 100 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality logic hardware using circuit technology such as, for example, ASIC, complementary metal oxide semiconductor (CMOS) or transistor-transistor logic (TTL) technology, or any combination thereof.

For example, computer program code to carry out operations by the system 100 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Locality-Aware Rulebook Structure (i2o and o2i)

A locality-aware rulebook, such as rulebook(s) 132 generated via locality-aware rulebook generator 130 (FIG. 1, already discussed), may encode the receptive/response field for every voxel in the pointcloud of interest. The structure for the locality-aware rulebook contains a list of rulebook lines (“rb-lines”), where each rb-line stores neighborhood information for a given input or output voxel. There are two variants of the locality-aware rulebook to encoding receptive field or the response field for the pointcloud data. For a first variant, the i2o rulebook, each rb-line corresponds to an input voxel and includes: a) an index of the input voxel representing the offset address to the voxel data, b) a bitmask with ‘1’s indicating valid output voxels in an output response field (ORF) of the input voxel and bit-locations indicating indices of weights which need to be multiplied with the input voxel data to compute the corresponding output voxel data, and c) indices of all output voxels in the ORF of the input voxel corresponding to the ‘1’s in the bitmask and in that order. For a second variant, the o2i rulebook, each rb-line corresponds to an output voxel and includes: a) an index of the output voxel representing the offset address to the voxel data, b) a bitmask with ‘1’s indicating valid input voxels in an input receptive field (IRF) of the output voxel and bit-locations indicating indices of weights which need to be multiplied with corresponding input voxel data to compute the output voxel data, and c) indices of all input voxels in the IRF of the output voxel corresponding to the ‘1’s in the bitmask and in that order. Further details of these variants of the locality-aware rulebook are provided with reference to FIGS. 2A-2C.

Turning now to FIG. 2A, a diagram is provided illustrating aspects of example locality-aware rulebooks according to one or more embodiments, with reference to components and features described herein including but not limited to the figures and associated description. The rulebooks shown in FIG. 2A correspond to an iso-resolution network layer for a neural network using two-dimensional (2D) sparse convolution with a 3×3 kernel (e.g., filter) such that the input and output resolution for the layer is the same. A first rulebook variant, i2o rulebook 210, is shown which includes an i2o data structure 211. While not shown in its entirety, the i2o data structure 211 includes three rb-lines corresponding to input voxel indices 4, 5 and 6 and, for each input voxel rb-line, the corresponding bitmask and output voxel indices. The diagram further shows an example set of input activation data 212 with indices representing active (i.e., non-zero) data points and corresponding example set of output activation data 213 with indices representing active (i.e., non-zero) data points. As illustrated for the ORF, input voxel 4 contributes to output voxels 5, 3 and 4 via the corresponding weights w3, w4 and w5, as shown in the rb-line for input voxel 4. Also illustrated is input data subset 214, weight matrix 215 (reflecting weights w1, w2, . . . w9) and output data subset 216, showing a relationship between input voxel 4 and output voxel 5 via weight w3, as reflected in the rb-line for input voxel 4.

FIG. 2A also shows a second rulebook variant, o2i rulebook 220, which includes an o2i data structure 221. While not shown in its entirety, the o2i data structure 221 includes three rb-lines corresponding to output voxel indices 4, 5 and 6 and, for each output voxel rb-line, the corresponding bitmask and input voxel indices. The diagram further shows an example set of input activation data 222 with indices representing active (i.e., non-zero) data points and corresponding example set of output activation data 223 with indices representing active (i.e., non-zero) data points. As illustrated for the IRF, input voxels 4, 3 and 5 contribute to output voxel 4 via the corresponding weights w5, w6 and w7. Also illustrated is input data subset 224, weight matrix 225 (reflecting weights w1, w2, . . . w9) and output data subset 226, showing a relationship between input voxel 5 and output voxel 4 via weight w7, as reflected in the rb-line for output voxel 4.

FIG. 2B provides a diagram illustrating aspects of example locality-aware rulebooks according to one or more embodiments, with reference to components and features described herein including but not limited to the figures and associated description. The rulebooks shown in FIG. 2B correspond to a downsampling network layer for a neural network using 2D sparse convolution with a 3×3 kernel (e.g., filter) such that the output resolution for the layer is one-half of the input. Two rulebook variants are shown, i2o rulebook 240 and o2i rulebook 250. i2o rulebook 240 has an i2o data structure 241 (partially illustrated) which includes three rb-lines corresponding to input voxel indices 4, 5 and 6 and, for each input voxel rb-line, the corresponding bitmask and output voxel indices. The diagram further shows an example set of input activation data 242 with indices representing active (i.e., non-zero) data points and corresponding example set of output activation data 243 with indices representing active (i.e., non-zero) data points. As illustrated for the ORF, input voxel 4 contributes to output voxels 4 and 1 via the corresponding weights w2 and w8, as shown in the rb-line for input voxel 4. Also illustrated is input data subset 244, weight matrix 245 (reflecting weights w1, w2, . . . w9) and output data subset 246, showing a relationship between input voxel 4 and output voxel 4 via weight w2, as reflected in the rb-line for input voxel 4.

Continuing with FIG. 2B, o2i rulebook 250 has an o2i data structure 251 (partially illustrated) which includes three rb-lines corresponding to output voxel indices 4, 5 and 6 and, for each output voxel rb-line, the corresponding bitmask and input voxel indices. The diagram further shows an example set of input activation data 252 with indices representing active (i.e., non-zero) data points and corresponding example set of output activation data 253 with indices representing active (i.e., non-zero) data points. As illustrated for the IRF, input voxels 4, 3, 5 and 6 contribute to output voxel 4 via the corresponding weights w2, w3, w5 and w7. Also illustrated is input data subset 254, weight matrix 255 (reflecting weights w1, w2, . . . w9) and output data subset 256, showing a relationship between input voxel 6 and output voxel 4 via weight w7, as reflected in the rb-line for output voxel 4.

FIG. 2C provides a diagram illustrating aspects of example locality-aware rulebooks according to one or more embodiments, with reference to components and features described herein including but not limited to the figures and associated description. The rulebooks shown in FIG. 2C correspond to an upsampling network layer for a neural network using 2D sparse convolution with a 3×3 kernel (e.g., filter) such that the output resolution for the layer is twice that of the input. Two rulebook variants are shown, i2o rulebook 270 and o2i rulebook 280. i2o rulebook 270 has an i2o data structure 271 (partially illustrated) which includes three rb-lines corresponding to input voxel indices 4, 5 and 6 and, for each input voxel rb-line, the corresponding bitmask and output voxel indices. The diagram further shows an example set of input activation data 272 with indices representing active (i.e., non-zero) data points and corresponding example set of output activation data 273 with indices representing active (i.e., non-zero) data points. As illustrated for the ORF, input voxel 4 contributes to output voxels 6, 5, 3 and 4 and 1 via the corresponding weights w3, w5, w7 and w8, as shown in the rb-line for input voxel 4. Also illustrated is input data subset 274, weight matrix 275 (reflecting weights w1, w2, . . . w9) and output data subset 276, showing a relationship between input voxel 4 and output voxel 6 via weight w3, as reflected in the rb-line for input voxel 4.

Continuing with FIG. 2C, o2i rulebook 280 has an o2i data structure 281 (partially illustrated) which includes three rb-lines corresponding to output voxel indices 4, 5 and 6 and, for each output voxel rb-line, the corresponding bitmask and input voxel indices. The diagram further shows an example set of input activation data 282 with indices representing active (i.e., non-zero) data points and corresponding example set of output activation data 283 with indices representing active (i.e., non-zero) data points. As illustrated for the IRF, input voxels 1 and 4 contribute to output voxel 4 via the corresponding weights w2 and w8. Also illustrated is input data subset 284, weight matrix 285 (reflecting weights w1, w2, . . . w9) and output data subset 286, showing a relationship between input voxel 4 and output voxel 4 via weight w8, as reflected in the rb-line for output voxel 4.

As shown in FIGS. 2A-2C, there is overlap of indices among rb-lines demonstrating the capability for voxel data reuse across rb-lines. For example, o2i data structure 221 shows that rb-lines for output voxels 4 and 5 both receive contributions from input voxel 4; output voxels 5 and 6 both receive contributions from input voxels 5 and 6; and output voxels 4, 5 and 6 all receive contributions from input voxel 5. Thus, for example, a single retrieval of data for input voxel 4 may be re-used in at least two calculations. Depending on numbers of channels in the input feature map (IFM) and output feature map (OFM) and resolution sizes of input/output spaces, as well as tiling selection, one of the two variants of the rulebook structure may provide a better opportunity for data reuse over the other. Accordingly, dataflow may be explored for both the variants to determine optimal dataflow. Encoding all voxels in a receptive field (or response field) in a rb-line and co-locating rb-lines may ensure high data reuse, resulting in reduced data accesses.

Tiling for 3D Spatially Sparse Pointcloud Processing

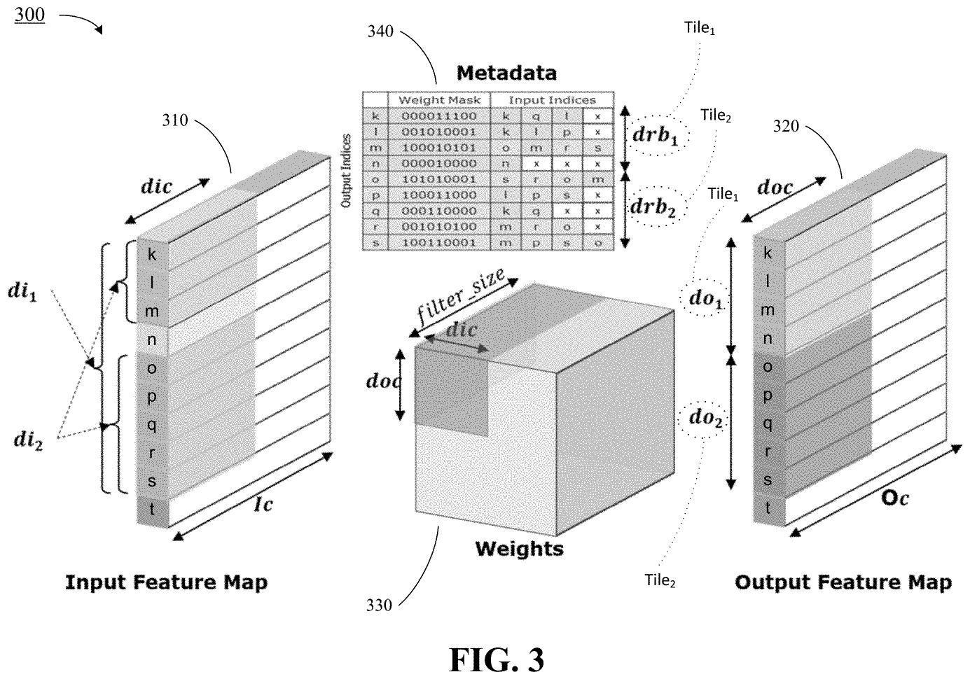

FIG. 3 provides a diagram 300 illustrating aspects of an example of tiling in optimizing 3D pointcloud data processing according to one or more embodiments, with reference to components and features described herein including but not limited to the figures and associated description. Typically, the sizes of input, output feature maps and weights will exceed the available on-chip memory. Accordingly, computation is performed by bringing in smaller subsets of input, output and weight data that can fit in memory. To complete the computation, subsets of input or output or weight data may be fetched multiple times depending on the order of processing. Tiling is a process by which subsets of input voxels or output voxels and input or output channels (i.e., each subset known as a “tile”) may be grouped and then processed in stages, saving memory and data accesses. A tile may be defined by a set of parameters: drb, dic, and doc, where drb refers to the number of rb-lines in the tile, and dic and doc refer to the number of input channels and output channels in the tile, respectively. An IFM tile consists of di input voxels, with each voxel having dic number of elements (e.g., channels). Similarly, an OFM tile contains do output voxels and doc elements (e.g., channels) per voxel. For an i2o rulebook, drb will be equal to di, and do may vary across tiles based on sparsity. For an o2i rulebook, drb will be equal to do, and di may vary across tiles based on sparsity.

As shown in FIG. 3, a 1D input feature map (IFM) 310 contains input voxels with input voxel indices k, l, m, . . . , s and t. The input voxel tiles have dic input channels. IC represents the number of input channels for the IFM 310. A 1D output feature map (OFM) 320 contains output voxels with output voxel indices k, l, m, . . . , s and t, where the output voxel tiles have doc output channels. OC represents the number of output channels for the OFM 320. A multi-dimensional weight matrix 330 may have a dimension equal to a filter (i.e., kernel) size, and may likewise be viewed in terms of input channels dic and output channels doc.

Also shown in FIG. 3 is an example locality-aware rulebook (an o2i rulebook) with o2i data structure 340 (partially illustrated) which includes nine rb-lines corresponding to output voxel indices k through s and, for each output voxel rb-line, the corresponding bitmask and input voxel indices, where “x” indicates end of an rb line. For illustrative purposes, the rb-lines in rulebook 340 for the output voxels have been organized into two tiles: tile₁ which has four output voxels {k, l, m, n} with drb₁ (number of rb-lines in tile₁) equal to 4; and tile₂ which has five output voxels {o, p, q, r, s} with drb₂ (number of rb-lines in tile₂) equal to 5. The tiles are shown for the OFM 320, where tile₁ covers voxels {k, l, m, n} with do₁ (number of output voxels in tile₁) equal to 4, and where tile₂ covers voxels {o, p, q, r, s} with do₂ (number of output voxels in tile₂) equal to 5. For the IFM 310, tile₁ (indicated by di₁) includes contributions from 9 unique input voxels {k, l, m, n, o, p, q, r, s} while tile₂ (indicated by di₂) includes contributions from 8 unique input voxels {k, l, m, o, p, q, r, s}. As illustrated in FIG. 3, with an o2i rulebook tiling may be visualized as a set of contiguous output voxels and scattered input voxels (in some cases, input voxel scattering may be more pronounced than illustrated in FIG. 3). Similarly, tiling for an i2o rulebook (not shown) could be visualized as a set of contiguous input voxels and scattered output voxels. It will be understood that, although FIG. 3 illustrates tiles having a different number of rb-lines, tiles may be selected based on a uniform tile size with each tile having an equal number of rb-lines.

Sparsity Attributes

Sparsity attributes may be generated to represent the sparsity-dependent variation in data accesses and the number of operations in spatial regions in the pointcloud data. Sparsity attributes may be extracted through a single pass inspection of input pointcloud data. Sparsity attributes may encode local sparsity structure in form of memory-size requirements and data-accesses over a range of region-sizes. The region-sizes represent a large number of regions in the given input pointcloud. This enables to determine net data accesses for each valid tiling option without needing to re-process the input pointcloud multiple times.

As discussed above with tiling, for a given drb (the number of rb-lines in tile) and rulebook, di (the number of input voxels for an o2i rulebook) or do (the number of output voxels for an i2o-rulebook) may vary across tiles as local sparsity may differ across regions in an input pointcloud. For a kth tile with drb rb-lines, doₖ and diₖ may be expressed as follows:

$$\begin{matrix}Equation 1 ( a ) \text{-} 1 ( b ) \text{:} & \\ For {k}^{th} tile in i 2 o \text{:} {di}_{k} = drb ; {do}_{k} = size\_of ( {⋃}_{j = k \times drb}^{( k + 1 ) \times drb} {ORF}_{j} ) ; \\ {rb}_{k} = {\sum }_{j = k \times drb}^{( k + 1 ) \times drb} size\_of ( {ORF}_{j} ) \\ For {k}^{th} tile in o 2 i \text{:} {do}_{k} = drb ; {di}_{k} = size\_of ( {⋃}_{j = k \times drb}^{( k + 1 ) \times drb} {IRF}_{j} ) ; \\ {rb}_{k} = {\sum }_{j = k \times drb}^{( k + 1 ) \times drb} size\_of ( {IRF}_{j} ) & ( 4 )\end{matrix}$$

where U denotes the union operator as a set collection of unique elements, rbₖ represents size of local neighborhood, and i2o/o2i identify the types of rulebooks (i2o rulebook or o2i rulebook, respectively). To model these sparsity dependent values (diₖ, doₖ, and rbₖ) as function of drb, two sparsity attributes may be defined as follows:

$$\begin{matrix}Equation 2 ( a ) \text{-} 2 ( b ) \text{:} \\ o 2 {i}_{k} ( drb ) = \frac{{di}_{k}}{drb} ; o 2 {rb}_{k} ( drb ) = \frac{{rb}_{k}}{drb} \\ i 2 {o}_{k} ( drb ) = \frac{{do}_{k}}{drb} ; i 2 {rb}_{k} ( drb ) = \frac{{rb}_{k}}{drb}\end{matrix}$$

These sparsity attributes may be computed by pre-processing an o2i rulebook and/or and i2o rulebook over a range of drb values (i.e., a range of potential tile sizes). FIG. 4A provides a diagram illustrating these data sparsity attributes, according to one or more embodiments, for an o2i-rulebook for a typical pointcloud in the ScanNet dataset. Plot 401 illustrates the behavior of o2iₖ(drb) as drb (i.e., tile size) increases. At each drb value, the plot also shows the behavior of o2iₖ(drb) across k tiles within the pointcloud. The darker line 402 shows the 90th quantile of values of o2iₖ(drb) across all tiles of size drb. The plot further indicates (label 403) o2i_{avg}(drb). Similarly, plot 405 illustrates the behavior of o2rbₖ(drb) as drb (i.e., tile size) increases. The darker line 406 shows the 90th quantile of values of o2rbₖ(drb) across all tiles of size drb. The plot further indicates (label 407) o2rb_{avg}(drb). Further, it should be noted that for a given value of drb, the values of o2iₖ(drb) and o2rbₖ(drb) can also vary for each tile (k).

Using these sparsity concepts, a set of sparsity attributes may be defined for an entire pointcloud data set, as follows, for use in determining an optimal processing dataflow:

$$\begin{matrix}Equation 3 ( a ) \text{-} 3 ( h ) \text{:} \\ o 2 i \text{-} rulebook \to o 2 {i}_{max} ( drb ) = {Max}_{k} ( o 2 {i}_{k} ( drb ) ) ; \\ o 2 {rb}_{max} ( drb ) = {Max}_{k} ( o 2 {rb}_{k} ( drb ) ) \\ i 2 o \text{-} rulebook \to i 2 {o}_{max} ( drb ) = {Max}_{k} ( i 2 {o}_{k} ( drb ) ) ; \\ i 2 {rb}_{max} ( drb ) = {Max}_{k} ( i 2 {rb}_{k} ( drb ) ) \\ o 2 i \text{-} rulebook \to o 2 {i}_{avg} ( drb ) = {Avg}_{k} ( o 2 {i}_{k} ( drb ) ) ; \\ o 2 {rb}_{avg} ( drb ) = {Avg}_{k} ( o 2 {rb}_{k} ( drb ) ) \\ i 2 o \text{-} rulebook \to i 2 {o}_{avg} ( drb ) = {Avg}_{k} ( i 2 {o}_{k} ( drb ) ) ; \\ i 2 {rb}_{avg} ( drb ) = {Avg}_{k} ( i 2 {rb}_{k} ( drb ) )\end{matrix}$$

Sparsity-Aware Optimal Dataflow

An optimal 3D pointcloud processing dataflow for tile-based execution via the system of FIG. 1 (already discussed) for a given 3D pointcloud data set may be determined using an analytical framework based on the sparsity attributes as defined herein. FIG. 5 provides a flow chart illustrating an example process 500 for optimizing 3D pointcloud data processing dataflow according to one or more embodiments, with reference to components and features described herein including but not limited to the figures and associated description. Process 500 may be carried out, for example, by sparsity-aware dataflow optimizer 150.

At processing block 510, for the given input pointcloud the two versions of locality-aware rulebooks (namely, an i2o-rulebook and an o2i-rulebook) may be generated. In some embodiments, only one version (e.g., either an i2o-rulebook and an o2i-rulebook) may be generated for the pointcloud. At processing block 520 the sparsity attributes, already discussed, may be computed.

At processing block 530, for given neural network layer and architecture parameters, tile candidates may be selected such that they fit within constrained on-chip (or cache) memory. Tile size may be estimated for a candidate tile (drb, dic, doc) using the rulebook-specific max sparsity-attributes (already discussed) o2iₘₐₓ and o2rbₘₐₓ (for an o2i-rulebook) or i2oₘₐₓ and i2rbₘₐₓ (for an i2o-rulebook). As discussed previously, a candidate tile is defined by 3 parameters: drb (subset of rulebook lines, dic (subset of input channels), and doc (subset of output channels). For an o2i-rulebook, estimated tile size may be computed as follows:

sizeₒ₂ᵢ(drb,dic,doc)=o2iₘₐₓ(drb)×drb×dic×fm_prec+drb×doc×fm_prec+F×dic×doc×wt_prec+drb×(k_{rb}+o2rbₘₐₓ(drb))×rb_prec Equation 4:

where F is the number of coefficients in the kernel (i.e., filter), and fm_prec, wt_prec, and rb_prec are the precisions in bytes for feature maps, weights and rulebook data respectively. The term k_{rb} is a constant to account for the bitmask and other metadata in each rulebook line. The parameters drb, dic and doc are the tile parameters (already discussed) for each candidate tile. A similar computation may be used to estimate tile sizes for an i2o rulebook using the attributes i2oₘₐₓ and i2rbₘₐₓ. Those tiles for which sizeₒ₂ᵢ(drb, dic, doc) exceed the available on-chip or cache memory are eliminated from further consideration (and similarly for tile size estimates for an i2o rulebook).

At processing block 540, iterate over tile candidates to determine the number of data accesses for each combination of dataflow (loop order) parameters. The computations in convolution neural networks (CNNs) involve three nested loops, one running over input/output voxel indices in spatial dimension, one running over input channels, and one running over output channels. These loops maybe arranged in different orders—also known as walk-pattern (WP). The data fetched in outer loops can be reused for calculations in inner loops and therefore can be kept stationary in the memory. For example, if the innermost loop is running over input channels, input feature map (IFM) data and weight data is fetched in the innermost loop and output feature map (OFM) data is fetched in an outer loop. In such a case the same OFM data may be reused in the innermost loop, and this loop order is termed as Output Stationary (OS). Similarly, if the innermost loop is running over output channels, the IFM data may be reused in the innermost loop, and this loop order is termed as Input stationary (IS). If the innermost loop is running over input, output voxel indices, weight data may be reused, and this loop order is termed as Weight stationary (WS). The total data accesses in computation may depend on the size of data tiles used in each loop and the order of loops. In the case of dense data, each tile contains the same amount of data. On the other hand, in case of spatially sparse data, each tile may contain a varying number of input and/or output voxels. For the sparse data, the number of data accesses may be estimated based on the average sparsity attributes. For example, the number of data accesses (Accₒ₂ᵢ) for an o2i-rulebook for each potential tile size and loop order combination may be estimated based on the o2i average sparsity attributes (o2i_{avg}, o2rb_{avg}) as follows:

$$Equation 5 \text{:}$$

$${Acc}_{o 2 i} ( WP , drb , dic , doc ) = {g}_{WP , WS} ( ⌈ \frac{Rb}{drb} ⌉ ) ( Ic \times Oc \times F ) \times wt\_prec + {g}_{WP , IS} ( ⌈ \frac{Oc}{doc} ⌉ ) \times o 2 {i}_{avg} ( drb ) \times Rb \times Ic \times fm\_prec + ( 2 \times {g}_{WP , OS} ( ⌈ \frac{Ic}{dic} ⌉ ) - 1 ) \times Rb \times Oc \times fm\_prec + {h}_{WP} ( {g}_{WP , IS} ( ⌈ \frac{Oc}{doc} ⌉ ) \times {g}_{WP , OS} ( ⌈ \frac{Ic}{dic} ⌉ ) ) \times ( {k}_{rb} + o 2 {rb}_{avg} ( drb ) ) \times Rb \times rb\_prec$$

$$where$$

$${g}_{WP , X} ( y ) = \{ \begin{matrix}1 & if ( WP = X ) \\ y & otherwise\end{matrix} \\ {h}_{WP} ( y ) = \{ \begin{matrix}1 & if WP iterates over \\ & Rb lines in the outermost loop \\ y & otherwise\end{matrix}$$

and where Ic, Oc and Rb represent number of input channels, number of output channels and number of rb-lines in the given network layer respectively; and where WP denotes a candidate walk-pattern (i.e., loop order) which may be chosen over a set of Input-Stationary (IS), Output-Stationary (OS), and/or Weight-Stationary (WS) walk-patterns. These computations are repeated for each combination of tile size (drb, dic, doc) and WP (loop order). For example, for each given tile size (drb, dic, doc) a variety of walk patterns may be applied, and the number of data accesses may be computed for each combination. Similar computations may be used to estimate the number of data accesses using an i2o-rulebook based on the i2o average sparsity attributes (i2o_{avg}, i2rb_{avg}).

At processing block 550, for given neural network layer and architecture parameters, a tile size and loop order combination is selected to meet optimization criteria, once the optimizer has explored the potential dataflow combinations for one or both the variants of the locality-aware rulebook (block 540). For example, where the optimal dataflow is determined based on optimization criteria of minimizing data accesses, the tile size and loop order combination that results in the minimum number of data accesses is selected. Once the optimal tile size and loop order combination is selected, the optimal tile size and loop order may be provided to the compute engine (neural network) for processing the pointcloud data set, as illustrated in FIG. 1 (already discussed).

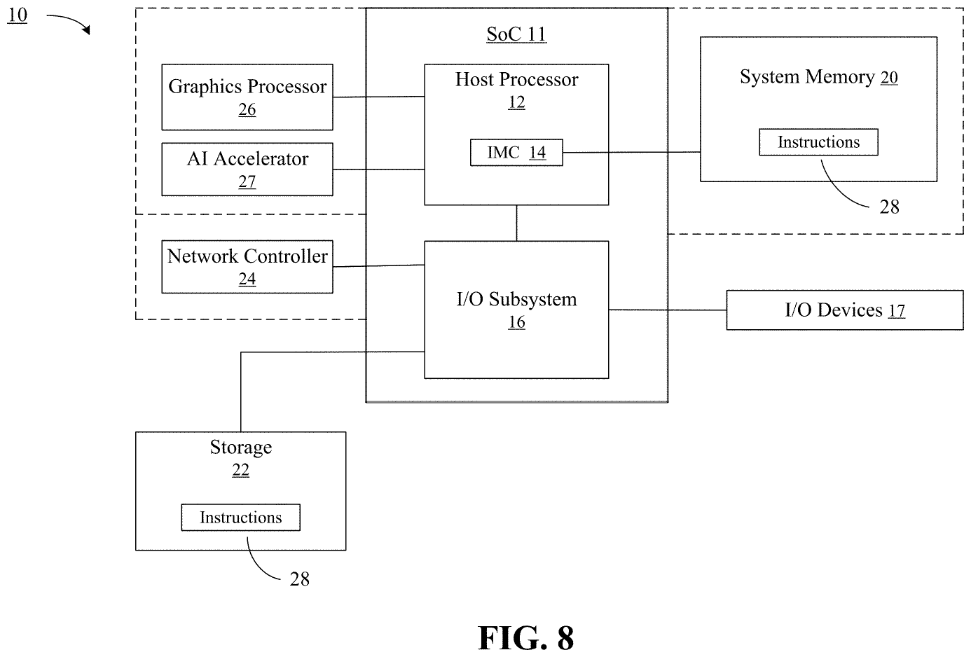

The process 500 may be implemented in a computing system such as, e.g., the system 100 described herein with reference to FIG. 1, or the computing system 10 described herein with reference to FIG. 8, discussed below. The process 500 may be performed by or under direction of an operating system (e.g., an operating system running on computing system 10). More particularly, the process 500 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

For example, computer program code to carry out operations shown in the process 500 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Meta-Sparsity Attributes and Offline Stage Processing

Sparsity attributes as discussed above may be categorized into two sets: (a) common attributes which are consistent across pointclouds—referred to as Meta-Sparsity Attributes (MSA), and (b) Input Specific Attributes (ISA) which vary highly across pointclouds. Since the extraction of sparsity attributes and the dataflow exploration as discussed above may be computationally intensive and may therefore add to latency overhead, a further improvement in the optimization techniques herein may be obtained through pre-computing meta-sparsity attributes in an offline stage over a representative set of M sample pointclouds for selected binned values of ISA. The MSA refers to the attributes which remain consistent across a class of pointclouds. Meta sparsity attributes, thus, serve as approximation to certain of the actual sparsity attributes of pointcloud data sets.

For example, behavior of the two types of sparsity attributes, o2i(drb) and o2rb(drb), across a set of point clouds, is illustrated in FIG. 4B, which shows the values of sparsity attributes o2i_{avg}(drb) and o2rb_{avg}(drb) for different point clouds over a range of drb values. It may be observed from FIG. 4B that, at each drb, the sparsity attribute o2i_{avg}(drb) correlates well across point clouds (see plot 411), while the sparsity attribute o2rb_{avg}(drb) varies significantly across point clouds (see plot 415). Further, the sparsity attribute o2rb_{avg}(drb)—which represents an average receptive field (ARF)—remains approximately the same across values of drb, and can thus be the ISA. Accordingly, based on the behavior of o2i_{avg}(drb), in computing the estimated number of data accesses per Equation 5 above, the sparsity attribute o2i_{avg} may be replaced with the MSA mo2i_{avg}(drb), as computed in Equation 6 below. Likewise, in computing the estimated tile size per Equation 4 above, the sparsity attribute o2iₘₐₓ may be replaced with the MSA o2i_{Q_tile(n)} as determined in Equation 7 below. In addition, based on the behavior of o2rb(drb), the sparsity attributes o2rbₘₐₓ (drb) in Equation 4 and o2rb_{avg}(drb) in Equation 5 may be replaced with an ARF value (for the sample pointcloud) from a range of potential ARF values. By using a range of ARF values from a set of sample pointclouds, an optimal tile and loop order may be computed for each ARF value.

An average receptive field (ARF) may be computed for each pointcloud as an input-dependent attribute. The ARF may be computed by averaging each of the receptive fields in the rulebook, where each rb-line represents the receptive field for a given voxel. That is, ARF may be calculated by summing of number of entries on each rulebook line for all rulebook lines and dividing it by number of rulebook lines. ARF may represent o2rb_{avg} for an o2i rulebook (or i2rb_{avg} for an i2o rulebook), which is also essentially invariant (i.e., variation is negligible) to the value of drb. The ARF remains consistent within a pointcloud, but the ARF will vary significantly across pointclouds. Using meta-sparsity attributes, optimal dataflow may be pre-computed in the offline stage over a range ARFs (e.g., ARF₁, . . . ARFₘ, . . . ARF_{M}) for a set of sample pointclouds and a table of optimal dataflow selections (tile size and loop order combinations), one for each ARF, may be compiled. The set of ARF values may be selected by sufficiently binning the entire range of ARFs, for example by processing a sufficient number of representative sample pointcloud data sets. As an example, assume that ARF can vary over a range from 10-25, and in steps of 0.5. Then optimal tile/loop order may be calculated for pointclouds having ARF values of 10, 10.5, . . . 24.5, 25 (a total of approximately 30 such ARF values in this example). Representative pointcloud data sets may be obtained, for example, from the same type of sensor or from similar views. Thus, with sufficient variety in ARFs in the offline stage, once the table is compiled ARF may be used as an index to select an optimal tile size and loop order combination in a runtime stage for a given input pointcloud of interest with ARFᵢ.

For purposes of estimating data accesses, the MSA mo2i_{avg}(drb) may be computed over a range of pointclouds (P=1 to M) for an o2i-rulebook as follows:

$$\begin{matrix}Equation 6 \text{:} \\ mo 2 {i}_{avg} ( drb ) = {\sum }_{pointcloud P = 1}^{M} o 2 {i}_{avg}^{P} ( drb ) / M\end{matrix}$$

A similar computation may be made for the MSA mi2o_{avg}(drb) for an i2o-rulebook. Similar to mo2i_{avg}(drb), another MSA, o2i_{Q_tile(n)} may be defined for tile size estimation, where o2i_{Q_tile(n)} represents the n-th quantile of the attribute o2i_{avg} such that:

Probability(o2i_{avg}^{P}(drb)≤o2i_{Q_tile(n)}(drb))=n, for 1≤P<M Equation 7:

For example, for 90th-quantile (n=0.9), o2i_{Q_tile(n)} is chosen such that it is larger than the sparsity attribute o2i_{avg}(drb) of 90% of pointclouds. A similar computation may be made for MSA i2o_{Q_tile(n)} for an i2o-rulebook. For example, with n=0.9, then 90% of the actual data tiles during a runtime stage are likely to fit within the size estimated based on q_{o2idrb}(n). During the runtime stage, if the data tile exceeds the allocated size based on the estimated size, the tile may be split into two or more sub-tiles such that size requirement for each sub-tile does not exceed the constrained memory size.

Once the optimal tile size and loop order combinations have been determined and is compiled (e.g., into a lookup table) in the offline stage, a given input pointcloud of interest may be processed in the runtime stage. The input pointcloud data set may have an average receptive filed ARFᵢ, and the optimal tile size and loop-order for processing the input pointcloud may be obtained through a table look-up based on ARFᵢ.

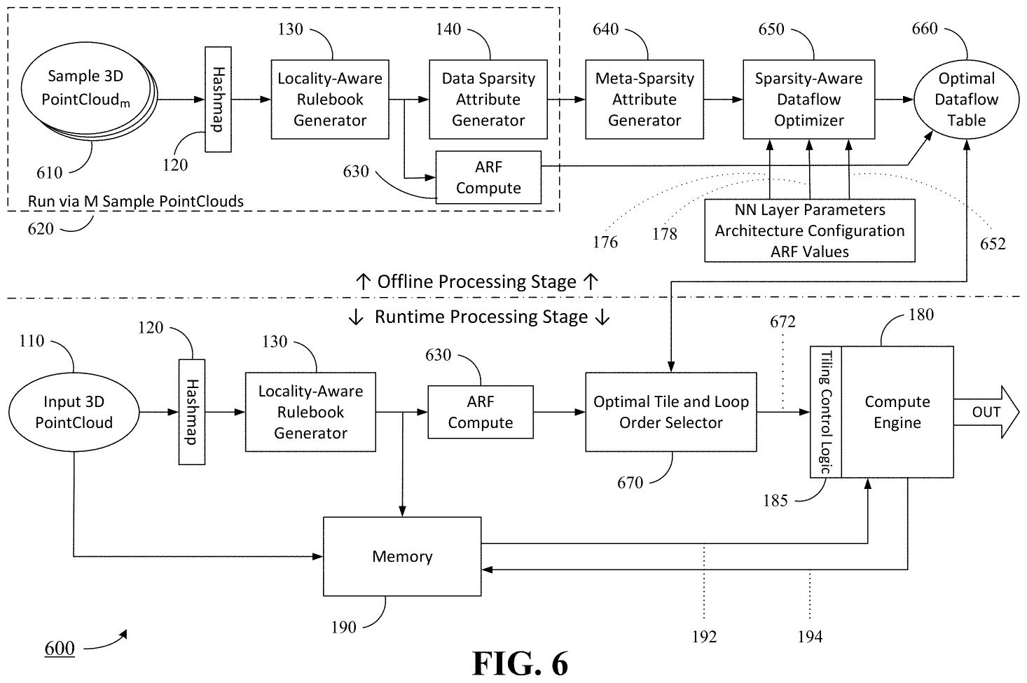

FIG. 6 shows a block diagram of an example system 600 for optimizing 3D pointcloud data processing according to one or more embodiments, with reference to components and features described herein including but not limited to the figures and associated description. The system 600 as shown in FIG. 6 utilizes the offline stage processing described above and includes many of the optimization system components and procedures as shown in and described above for system 100 with reference to FIG. 1, already discussed.

The system 600 includes offline stage processing for determining sparsity attributes for a representative set of M sample 3D pointcloud data sets 610 (e.g., pointcloud₁, . . . pointcloudₘ, . . . , pointcloud_{M}, where m may be in the range 1 . . . M). A set of offline procedures 620 may include applying hashmap 120, locality-aware rulebook generator 130, data sparsity attribute generator 140 and ARF compute 630 for each of the M sample 3D pointcloud data sets. ARF compute 630 may compute the average receptive field value for a given pointcloud based on the rb-lines for the respective rulebook(s). Meta-sparsity attribute generator 640 may compute meta-sparsity attributes based on the generation of the rulebooks and the data sparsity attributes via procedures 620. The meta-sparsity attributes are approximations to the actual data sparsity attributes. Sparsity-aware dataflow optimizer 650 may evaluate candidate tile size and loop order combinations in a manner similar to sparsity-aware dataflow optimizer 150 (FIG. 1, already discussed), e.g. using the evaluation procedures similar to those described with reference to process 500 (FIG. 5, already discussed) to generate the optimal tile size and loop order for each representative pointcloud. Inputs to sparsity-aware dataflow optimizer 650 may include the meta sparsity attributes from meta-sparsity attribute generator 640, network and architecture configuration parameters for the compute engine 180 (which may include neural network (NN) layer parameters 176 and architecture configuration parameters 178), along with a set of ARF values 652. In some embodiments, sparsity-aware dataflow optimizer 650 may evaluate optimal tile size and loop order based on the data sparsity attributes generated by data sparsity attribute generator 140 instead of the meta-sparsity attributes. For each sample pointcloud, the optimal tile size and loop order as determined by sparsity-aware dataflow optimizer 650 may be compiled, along with the respective ARF for the pointcloud, in a lookup table such as optimal dataflow table 660.

The system 600 includes runtime stage processing in which the system 600 may process one or more input 3D pointcloud data sets 110. Each input 3D pointcloud data sets 110 may, preferably, be obtained from a similar sensor type or similar data type or source as reflected by the representative sample pointcloud data sets used in the offline processing stage. The runtime stage for system 600 may include applying a hashmap 120 to the input 3D pointcloud data set 110, then processing with locality-aware rulebook generator 130 to generate the appropriate rulebooks (o2i and/or i2o rulebook variants). ARF compute 630 may compute the average receptive field value for the input pointcloud based on the rb-lines in the rulebook(s). Once the rulebook(s) and ARF are obtained for the input 3D pointcloud 110, optimal tile and loop order selector 670 queries optimal dataflow table 660, based on the ARF, to obtain the optimal tile size and loop order 672 for processing the input pointcloud 110. The optimal tile size and loop order 672 are provided to compute engine 180 for processing the input pointcloud 110, as described with reference to FIG. 1, already discussed.

Some or all components in the system 600 may be implemented using one or more of a CPU, a GPU, an A accelerator, an FPGA accelerator, an ASIC, and/or via a processor with software, or in a combination of a processor with software and an FPGA or ASIC. More particularly, components of the system 100 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

For example, computer program code to carry out operations by the system 600 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The technology described herein may be applied to various large, unstructured sparse data sets indifferent scenarios. For example, four-dimensional (4D) pointclouds, which include a 4th dimension for movement over time, may be processed using the systems and processes described above. Similarly, the techniques may be applied to N-dimensional sparse convolutions (N-dimensional CNNs) and to graph-based convolution networks (GNNs).

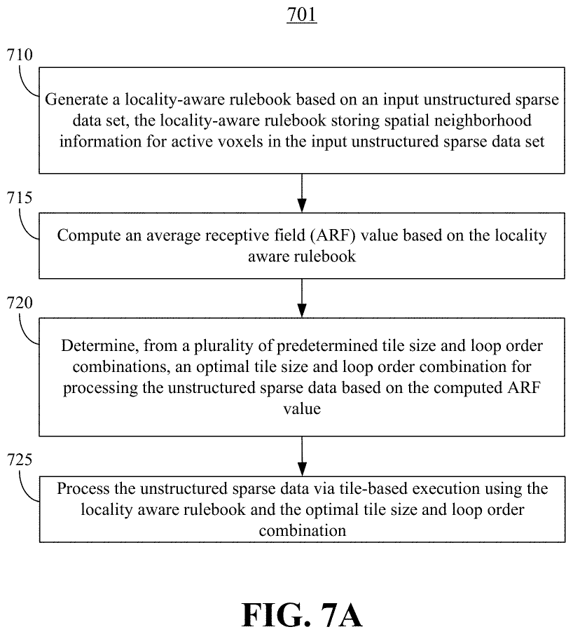

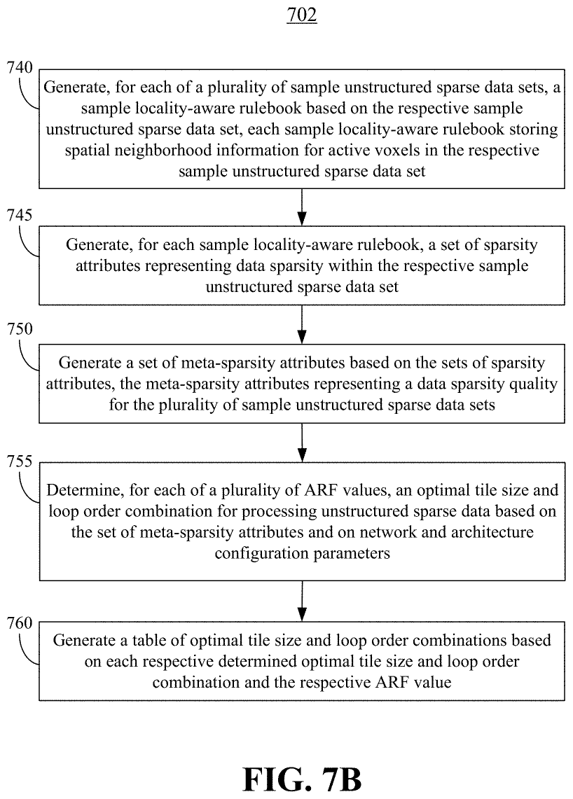

FIG. 7A provides a flow chart illustrating an example process 701 for optimizing processing of unstructured sparse data (such as, e.g., 3D pointcloud data) according to one or more embodiments, with reference to components and features described herein including but not limited to the figures and associated description. All or a portion of process 701 may be implemented as part of the runtime stage processing described herein with reference to FIG. 6, already discussed. Processing block 710 provides for generating a locality-aware rulebook based on an input unstructured sparse data set, the locality-aware rulebook storing spatial neighborhood information for active voxels in the input unstructured sparse data set. The input unstructured sparse data set may be a three-dimensional (3D) pointcloud data set. Processing block 715 provides for computing an average receptive field (ARF) value based on the locality aware rulebook. Processing block 720 provides for determining, from a plurality of predetermined tile size and loop order combinations, an optimal tile size and loop order combination for processing the unstructured sparse data based on the computed ARF value. The plurality of predetermined tile size and loop order combinations may have been derived based on data sparsity attributes, such as data sparsity attributes computed according to process 702 (FIG. 7B, below). Processing block 725 provides for processing the unstructured sparse data via tile-based execution using the locality aware rulebook and the optimal tile size and loop order combination, which may be performed by a compute engine (such as, e.g., a CNN). The compute engine may correspond to compute engine 180 (FIGS. 1 and 6, already discussed).

FIG. 7B provides a flow chart illustrating an example process 702 for optimizing processing of unstructured sparse data (such as, e.g., 3D pointcloud data) according to one or more embodiments, with reference to components and features described herein including but not limited to the figures and associated description. All or a portion of process 702 may be implemented as part of the offline stage processing described herein with reference to FIG. 6, already discussed. Processing block 740 provides for generating, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set. Each of the sample unstructured sparse data sets may be a 3D pointcloud data set. Processing block 745 provides for generating, for each sample locality-aware rulebook, a set of sparsity attributes representing data sparsity within the respective sample unstructured sparse data set. Processing block 750 provides for generating a set of meta-sparsity attributes based on the sets of sparsity attributes, the meta-sparsity attributes representing a data sparsity quality for the plurality of sample unstructured sparse data sets. Processing block 755 provides for determining, for each of a plurality of average receptive field (ARF) values, an optimal tile size and loop order combination for processing, by a compute engine, unstructured sparse data based on the set of meta-sparsity attributes and on network and architecture configuration parameters for the compute engine. Average receptive field (ARF) values may be computed for each of the plurality of sample unstructured sparse data sets based on the respective sample locality aware rulebook. Processing block 760 provides for generating a table of optimal tile size and loop order combinations based on each optimal tile size and loop order combination determined for each respective ARF value. The table may include a plurality of ARF values and, for each ARF value, the table may include the respective optimal tile and loop order combination determined for that ARF value. The set of optimal tile size and loop order combinations in the table may provide the plurality of predetermined tile size and loop order combinations (processing block 720, already discussed).

The processes 701 and/or 702 may be implemented in a computing system such as, e.g., the system 600 described herein with reference to FIG. 6, or the computing system 10 described herein with reference to FIG. 8, discussed below. The processes 701 and/or 702 may be performed by or under direction of an operating system (e.g., an operating system running on computing system 10). More particularly, the processes 701 and/or 702 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

For example, computer program code to carry out operations shown in the processes 701 and/or 702 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 8 shows a block diagram illustrating an example computing system 10 for optimizing 3D pointcloud data processing according to one or more embodiments, with reference to components and features described herein including but not limited to the figures and associated description. System 10 may generally be part of an electronic device/platform having computing and/or communications functionality (e.g., server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof. In the illustrated example, system 10 may include a host processor 12 (e.g., central processing unit/CPU) having an integrated memory controller (IMC) 14 that may be coupled to system memory 20. Host processor 12 may include any type of processing device, such as, e.g., microcontroller, microprocessor, RISC processor, ASIC, etc., along with associated processing modules or circuitry. System memory 20 may include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

System 10 may also include an input/output (I/O) subsystem 16. I/O subsystem 16 may communicate with for example, one or more input/output (I/O) devices 17, a network controller 24 (e.g., wired and/or wireless NIC), and storage 22. Storage 22 may be comprised of any appropriate non-transitory machine- or computer-readable memory type (e.g., flash memory, DRAM, SRAM (static random access memory), solid state drive (SSD), hard disk drive (HDD), optical disk, etc.). Storage 22 may include mass storage. In some embodiments, host processor 12 and/or I/O subsystem 16 may communicate with storage 22 (all or portions thereof) via network controller 24. In some embodiments, the system 10 may also include a graphics processor 26 (e.g., graphics processing unit/GPU) and an AI accelerator 27. In an embodiment, the system 10 may also include a vision processing unit (VPU), not shown.

Host processor 12 and I/O subsystem 16 may be implemented together on a semiconductor die as a system on chip (SoC) 11, shown encased in a solid line. SoC 11 may therefore operate as a computing apparatus for optimizing 3D pointcloud data processing. In some embodiments, SoC 11 may also include one or more of system memory 20, network controller 24, and/or graphics processor 26 (shown encased in dotted lines). In some embodiments, SoC 11 may also include other components of system 10.

Host processor 12 and/or I/O subsystem 16 may execute program instructions 28 retrieved from system memory 20 and/or storage 22 to perform one or more aspects of process 500 as described herein with reference to FIG. 5 and/or processes 701-702 as described herein with reference to FIGS. 7A-7B. System 10 may implement one or more aspects of system 100 and/or system 600 as described herein with reference to FIGS. 1 and 6. System 10 is therefore considered to be performance-enhanced at least to the extent that the technology provides processing of 3D pointcloud data through tile-based execution while optimizing dataflow based on data sparsity.

Computer program code to carry out the processes described above may be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 may include one or more of input devices, such as a touch-screen, keyboard, mouse, cursor-control device, touch-screen, microphone, digital camera, video recorder, camcorder, biometric scanners and/or sensors; input devices may be used to enter information and interact with system 10 and/or with other devices. I/O devices 17 may also include one or more of output devices, such as a display (e.g., touch screen, liquid crystal display/LCD, light emitting diode/LED display, plasma panels, etc.), speakers and/or other visual or audio output devices. Input and/or output devices may be used, e.g., to provide a user interface.

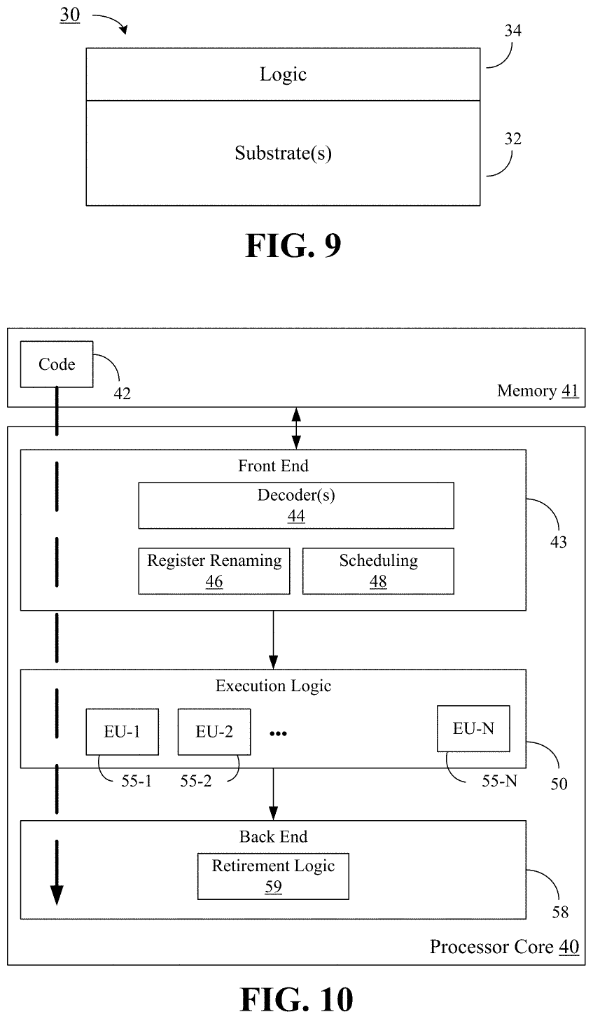

FIG. 9 shows a block diagram illustrating an example semiconductor apparatus 30 for optimizing 3D pointcloud data processing according to one or more embodiments, with reference to components and features described herein including but not limited to the figures and associated description. Semiconductor apparatus 30 may be implemented, e.g., as a chip, die, or other semiconductor package. Semiconductor apparatus 30 may include one or more substrates 32 comprised of, e.g., silicon, sapphire, gallium arsenide, etc. Semiconductor apparatus 30 may also include logic 34 comprised of, e.g., transistor array(s) and other integrated circuit (IC) components) coupled to the substrate(s) 32. Logic 34 may be implemented at least partly in configurable logic or fixed-functionality logic hardware. Logic 34 may implement system on chip (SoC) 11 described above with reference to FIG. 8. Logic 34 may implement one or more aspects of the processes described above, including process 500 as described herein with reference to FIG. 5 and/or processes 701-702 as described herein with reference to FIGS. 7A-7B. Logic 34 may implement one or more aspects of system 100 and/or system 600 as described herein with reference to FIGS. 1 and 6. Apparatus 30 is therefore considered to be performance-enhanced at least to the extent that the technology provides processing of 3D pointcloud data through tile-based execution while optimizing dataflow based on data sparsity.

Semiconductor apparatus 30 may be constructed using any appropriate semiconductor manufacturing processes or techniques. For example, logic 34 may include transistor channel regions that are positioned (e.g., embedded) within substrate(s) 32. Thus, the interface between logic 34 and substrate(s) 32 may not be an abrupt junction. Logic 34 may also be considered to include an epitaxial layer that is grown on an initial wafer of substrate(s) 34.

FIG. 10 is a block diagram illustrating an example processor core 40 according to one or more embodiments, with reference to components and features described herein including but not limited to the figures and associated description. Processor core 40 may be the core for any type of processor, such as a micro-processor, an embedded processor, a digital signal processor (DSP), a network processor, a graphics processing unit (GPU), or other device to execute code. Although only one processor core 40 is illustrated in FIG. 10, a processing element may alternatively include more than one of the processor core 40 illustrated in FIG. 10. Processor core 40 may be a single-threaded core or, for at least one embodiment, processor core 40 may be multithreaded in that it may include more than one hardware thread context (or “logical processor”) per core.

FIG. 10 also illustrates a memory 41 coupled to processor core 40. Memory 41 may be any of a wide variety of memories (including various layers of memory hierarchy) as are known or otherwise available to those of skill in the art. Memory 41 may include one or more code 42 instruction(s) to be executed by processor core 40. Code 42 may implement one or more aspects of the processes 500 and/or 701-702 described above. Processor core 40 may implement one or more aspects of system 100 and/or system 600. Processor core 40 follows a program sequence of instructions indicated by code 42. Each instruction may enter a front end portion 43 and be processed by one or more decoders 44. Decoder 44 may generate as its output a micro operation such as a fixed width micro operation in a predefined format, or may generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

Processor core 40 is shown including execution logic 50 having a set of execution units 55-1 through 55-N. Some embodiments may include a number of execution units dedicated to specific functions or sets of functions. Other embodiments may include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 may take a variety of forms as known to those of skill in the art (e.g., re-order buffers or the like). In this manner, processor core 40 is transformed during execution of code 42, at least in terms of the output generated by the decoder, the hardware registers and tables utilized by the register renaming logic 46, and any registers (not shown) modified by the execution logic 50.

Although not illustrated in FIG. 10, a processing element may include other elements on chip with processor core 40. For example, a processing element may include memory control logic along with processor core 40. The processing element may include I/O control logic and/or may include I/O control logic integrated with memory control logic. The processing element may also include one or more caches.

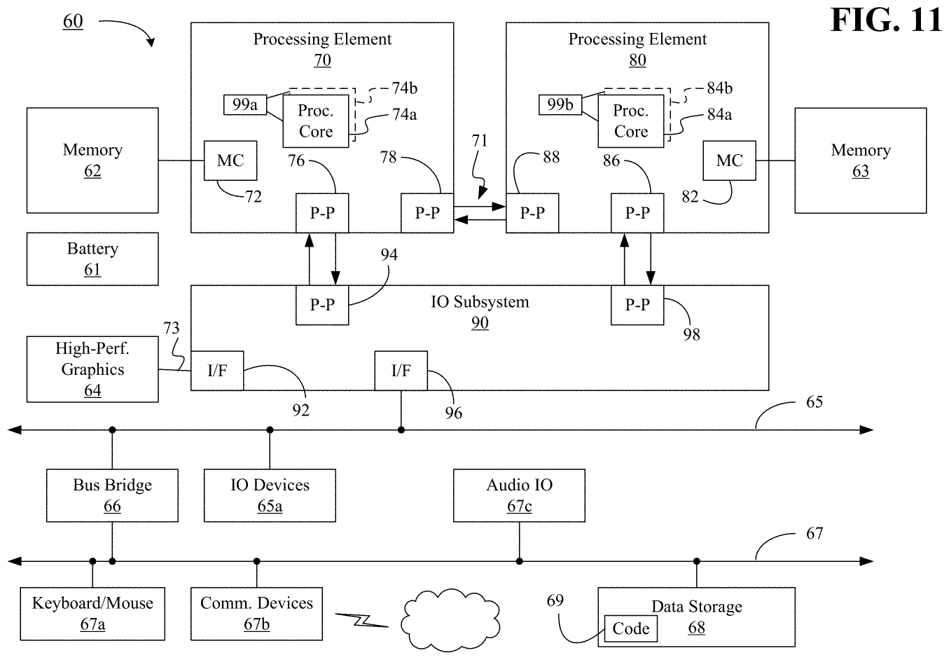

FIG. 11 is a block diagram illustrating an example of a multi-processor based computing system 60 according to one or more embodiments, with reference to components and features described herein including but not limited to the figures and associated description. Multiprocessor system 60 includes a first processing element 70 and a second processing element 80. While two processing elements 70 and 80 are shown, it is to be understood that an embodiment of the system 60 may also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 11 may be implemented as a multi-drop bus rather than point-to-point interconnect.

As shown in FIG. 11, each of processing elements 70 and 80 may be multicore processors, including first and second processor cores (i.e., processor cores 74a and 74b and processor cores 84a and 84b). Such cores 74a, 74b, 84a, 84b may be configured to execute instruction code in a manner similar to that discussed above in connection with FIG. 10.

Each processing element 70, 80 may include at least one shared cache 99a, 99b. The shared cache 99a, 99b may store data (e.g., instructions) that are utilized by one or more components of the processor, such as the cores 74a, 74b and 84a, 84b, respectively. For example, the shared cache 99a, 99b may locally cache data stored in a memory 62, 63 for faster access by components of the processor. In one or more embodiments, the shared cache 99a, 99b may include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments is not so limited. In other embodiments, one or more additional processing elements may be present in a given processor. Alternatively, one or more of processing elements 70, 80 may be an element other than a processor, such as an accelerator or a field programmable gate array. For example, additional processing element(s) may include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences may effectively manifest themselves as asymmetry and heterogeneity amongst the processing elements 70, 80. For at least one embodiment, the various processing elements 70, 80 may reside in the same die package.

The first processing element 70 may further include memory controller logic (MC) 72 and point-to-point (P-P) interfaces 76 and 78. Similarly, the second processing element 80 may include a MC 82 and P-P interfaces 86 and 88. As shown in FIG. 11, MC's 72 and 82 couple the processors to respective memories, namely a memory 62 and a memory 63, which may be portions of main memory locally attached to the respective processors. While the MC 72 and 82 is illustrated as integrated into the processing elements 70, 80, for alternative embodiments the MC logic may be discrete logic outside the processing elements 70, 80 rather than integrated therein.

The first processing element 70 and the second processing element 80 may be coupled to an I/O subsystem 90 via P-P interconnects 76 and 86, respectively. As shown in FIG. 11, the I/O subsystem 90 includes P-P interfaces 94 and 98. Furthermore, I/O subsystem 90 includes an interface 92 to couple I/O subsystem 90 with a high performance graphics engine 64. In one embodiment, bus 73 may be used to couple the graphics engine 64 to the I/O subsystem 90. Alternately, a point-to-point interconnect may couple these components.

In turn, I/O subsystem 90 may be coupled to a first bus 65 via an interface 96. In one embodiment, the first bus 65 may be a Peripheral Component Interconnect (PCI) bus, or a bus such as a PCI Express bus or another third generation I/O interconnect bus, although the scope of the embodiments are not so limited.

As shown in FIG. 11, various I/O devices 65a (e.g., biometric scanners, speakers, cameras, and/or sensors) may be coupled to the first bus 65, along with a bus bridge 66 which may couple the first bus 65 to a second bus 67. In one embodiment, the second bus 67 may be a low pin count (LPC) bus. Various devices may be coupled to the second bus 67 including, for example, a keyboard/mouse 67a, communication device(s) 67b, and a data storage unit 68 such as a disk drive or other mass storage device which may include code 69, in one embodiment. The illustrated code 69 may implement one or more aspects of the processes described above, including processes 500 and/or 701-702. The illustrated code 69 may be similar to code 42 (FIG. 10), already discussed. Further, an audio I/O 67c may be coupled to second bus 67 and a battery 61 may supply power to the computing system 60. System 60 may implement one or more aspects of system 100 and/or system 600.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

Embodiments of each of the above systems, devices, components and/or methods, including system 10, semiconductor apparatus 30, processor core 40, system 60, system 100, system 600, process 500, and/or processes 701-702, and/or any other system components, may be implemented in hardware, software, or any suitable combination thereof. For example, hardware implementations may include configurable logic such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Alternatively, or additionally, all or portions of the foregoing systems and/or components and/or methods may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples

Example 1 includes a computing system, comprising a processor, a memory coupled to the processor to store instructions which, when executed by the processor, cause the processor to generate a locality-aware rulebook based on an input unstructured sparse data set, the locality-aware rulebook storing spatial neighborhood information for active voxels in the input unstructured sparse data set, determine, from a plurality of predetermined tile size and loop order combinations, a tile size and loop order combination for processing the unstructured sparse data set based on an average receptive field (ARF) value, the ARF value computed based on the locality-aware rulebook, wherein the plurality of predetermined tile size and loop order combinations have been derived based on data sparsity attributes, and process by a compute engine the unstructured sparse data set via tile-based execution using the locality-aware rulebook and the tile size and loop order combination.

Example 2 includes the system of Example 1, wherein each line of the locality aware rulebook comprises one of an index of an input voxel representing an offset address for the input voxel data, a bitmask indicating active output voxels in an output response field of the input voxel and bit-locations of convolution weights to be applied, and indices of output voxels in the output response field, or an index of an output voxel representing an offset address for the output voxel data, a bitmask indicating active input voxels in an input receptive field of the output voxel and bit-locations of convolution weights to be applied, and indices of input voxels in the input receptive field.

Example 3 includes the system of Example 1, wherein the instructions, when executed, further cause the processor to generate, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set, generate, for each sample locality-aware rulebook, a set of sparsity attributes representing data sparsity within the respective sample unstructured sparse data set, the sparsity attributes computed over a range of a number of rulebook lines per tile, generate a set of meta-sparsity attributes based on the sets of sparsity attributes, the meta-sparsity attributes representing a data sparsity quality for the plurality of sample unstructured sparse data sets, and determine, for each of a plurality of average receptive field (ARF) values, a tile size and loop order combination for processing, by the compute engine, unstructured sparse data based on the set of meta-sparsity attributes and on network and architecture configuration parameters.

Example 4 includes the system of Example 3, wherein the instructions, when executed, further cause the processor to generate a table including a plurality of tile size and loop order combinations based on each respective determined tile size and loop order combination and the respective ARF value, wherein the tile size and loop order combinations in the table provide the plurality of predetermined tile size and loop order combinations, wherein each of the plurality of ARF values may be computed based on the respective sample locality aware rulebook.

Example 5 includes the system of Example 4, wherein each respective tile size and loop order combination is determined based on minimizing the number of data accesses required for the compute engine to process an unstructured sparse data set.

Example 6 includes the system of any of Examples 1-5, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set, wherein the sparsity attributes encode local sparsity structure in form of memory-size requirements and data-accesses over a range of region-sizes in the respective sample unstructured sparse data set, and wherein tile size includes a number of rulebook lines per tile and the loop order includes one of an input-stationary walk pattern, an output-stationary walk pattern, or a weight-stationary walk pattern.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to generate a locality-aware rulebook based on an input unstructured sparse data set, the locality-aware rulebook storing spatial neighborhood information for active voxels in the input unstructured sparse data set, compute an average receptive field (ARF) value based on the locality aware rulebook, and determine, from a plurality of predetermined tile size and loop order combinations, a tile size and loop order combination for processing the unstructured sparse data based on the computed ARF value, wherein the plurality of predetermined tile size and loop order combinations have been derived based on data sparsity attributes, wherein the locality-aware rulebook and the tile size and loop order combination are to be provided to a compute engine, the compute engine to process the unstructured sparse using the locality aware rulebook and the tile size and loop order combination.

Example 8 includes the apparatus of Example 7, wherein each line of the locality aware rulebook comprises one of an index of an input voxel representing an offset address for the input voxel data, a bitmask indicating active output voxels in an output response field of the input voxel and bit-locations of convolution weights to be applied, and indices of output voxels in the output response field, or an index of an output voxel representing an offset address for the output voxel data, a bitmask indicating active input voxels in an input receptive field of the output voxel and bit-locations of convolution weights to be applied, and indices of input voxels in the input receptive field.

Example 9 includes the apparatus of Example 7, wherein the logic is further to generate, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set, generate, for each sample locality-aware rulebook, a set of sparsity attributes representing data sparsity within the respective sample unstructured sparse data set, the sparsity attributes computed over a range of a number of rulebook lines per tile, generate a set of meta-sparsity attributes based on the sets of sparsity attributes, the meta-sparsity attributes representing a data sparsity quality for the plurality of sample unstructured sparse data sets, and determine, for each of a plurality of average receptive field (ARF) values, a tile size and loop order combination for processing, by the compute engine, unstructured sparse data based on the set of meta-sparsity attributes and on network and architecture configuration parameters.

Example 10 includes the apparatus of Example 9, wherein the logic is further to generate a table including a plurality of tile size and loop order combinations based on each respective determined tile size and loop order combination and the respective ARF value, wherein the tile size and loop order combinations in the table provide the plurality of predetermined tile size and loop order combinations, wherein each of the plurality of ARF values may be computed based on the respective sample locality aware rulebook.

Example 11 includes the apparatus of Example 10, wherein each respective tile size and loop order combination is determined based on minimizing the number of data accesses required for the compute engine to process an unstructured sparse data set.

Example 12 includes the apparatus of any of Examples 7-11, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set, wherein the sparsity attributes encode local sparsity structure in form of memory-size requirements and data-accesses over a range of region-sizes in the respective sample unstructured sparse data set, and wherein tile size includes a number of rulebook lines per tile and the loop order includes one of an input-stationary walk pattern, an output-stationary walk pattern, or a weight-stationary walk pattern.

Example 13 includes the apparatus of Example 7, wherein the logic coupled to the one or more substrates includes transistor channel regions that are positioned within the one or more substrates.

Example 14 includes at least one non-transitory computer readable storage medium comprising a set of instructions which, when executed by a computing system, cause the computing system to generate a locality-aware rulebook based on an input unstructured sparse data set, the locality-aware rulebook storing spatial neighborhood information for active voxels in the input unstructured sparse data set, compute an average receptive field (ARF) value based on the locality aware rulebook, and determine, from a plurality of predetermined tile size and loop order combinations, a tile size and loop order combination for processing the unstructured sparse data based on the computed ARF value, wherein the plurality of predetermined tile size and loop order combinations have been derived based on data sparsity attributes, wherein the locality-aware rulebook and the tile size and loop order combination are to be provided to a compute engine, the compute engine to process the unstructured sparse data using the locality aware rulebook and the tile size and loop order combination.

Example 15 includes the at least one non-transitory computer readable storage medium of Example 14, wherein each line of the locality aware rulebook comprises one of an index of an input voxel representing an offset address for the input voxel data, a bitmask indicating active output voxels in an output response field of the input voxel and bit-locations of convolution weights to be applied, and indices of output voxels in the output response field, or an index of an output voxel representing an offset address for the output voxel data, a bitmask indicating active input voxels in an input receptive field of the output voxel and bit-locations of convolution weights to be applied, and indices of input voxels in the input receptive field.

Example 16 includes the at least one non-transitory computer readable storage medium of Example 14, wherein the instructions, when executed, further cause the computing system to generate, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set, generate, for each sample locality-aware rulebook, a set of sparsity attributes representing data sparsity within the respective sample unstructured sparse data set, the sparsity attributes computed over a range of a number of rulebook lines per tile, generate a set of meta-sparsity attributes based on the sets of sparsity attributes, the meta-sparsity attributes representing a data sparsity quality for the plurality of sample unstructured sparse data sets, and determine, for each of a plurality of average receptive field (ARF) values, a tile size and loop order combination for processing, by the compute engine, unstructured sparse data based on the set of meta-sparsity attributes and on network and architecture configuration parameters.

Example 17 includes the at least one non-transitory computer readable storage medium of Example 16, wherein the instructions, when executed, further cause the computing system to generate a table including a plurality of tile size and loop order combinations based on each respective determined tile size and loop order combination and the respective ARF value, wherein the tile size and loop order combinations in the table provide the plurality of predetermined tile size and loop order combinations, wherein each of the plurality of ARF values may be computed based on the respective sample locality aware rulebook.

Example 18 includes the at least one non-transitory computer readable storage medium of Example 17, wherein each respective tile size and loop order combination is determined based on minimizing the number of data accesses required for the compute engine to process an unstructured sparse data set.

Example 19 includes the at least one non-transitory computer readable storage medium of any of Examples 14-18, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set, wherein the sparsity attributes encode local sparsity structure in form of memory-size requirements and data-accesses over a range of region-sizes in the respective sample unstructured sparse data set, and wherein tile size includes a number of rulebook lines per tile and the loop order includes one of an input-stationary walk pattern, an output-stationary walk pattern, or a weight-stationary walk pattern.

Example 20 includes a method of optimizing sparse data processing, comprising generating a locality-aware rulebook based on an input unstructured sparse data set, the locality-aware rulebook storing spatial neighborhood information for active voxels in the input unstructured sparse data set, computing an average receptive field (ARF) value based on the locality aware rulebook, and determining, from a plurality of predetermined tile size and loop order combinations, a tile size and loop order combination for processing the unstructured sparse data based on the computed ARF value, wherein the plurality of predetermined tile size and loop order combinations have been derived based on data sparsity attributes, wherein the locality-aware rulebook and the tile size and loop order combination are provided to a compute engine, the compute engine to process the unstructured sparse data using the locality aware rulebook and the tile size and loop order combination.

Example 21 includes the method of Example 20, wherein each line of the locality aware rulebook comprises one of an index of an input voxel representing an offset address for the input voxel data, a bitmask indicating active output voxels in an output response field of the input voxel and bit-locations of convolution weights to be applied, and indices of output voxels in the output response field, or an index of an output voxel representing an offset address for the output voxel data, a bitmask indicating active input voxels in an input receptive field of the output voxel and bit-locations of convolution weights to be applied, and indices of input voxels in the input receptive field.

Example 22 includes the method of Example 20, further comprising generating, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set, generating, for each sample locality-aware rulebook, a set of sparsity attributes representing data sparsity within the respective sample unstructured sparse data set, the sparsity attributes computed over a range of a number of rulebook lines per tile, generating a set of meta-sparsity attributes based on the sets of sparsity attributes, the meta-sparsity attributes representing a data sparsity quality for the plurality of sample unstructured sparse data sets, and determining, for each of a plurality of average receptive field (ARF) values, a tile size and loop order combination for processing, by the compute engine, unstructured sparse data based on the set of meta-sparsity attributes and on network and architecture configuration parameters.

Example 23 includes the method of Example 22, further comprising generating a table including a plurality of tile size and loop order combinations based on each respective determined tile size and loop order combination and the respective ARF value, wherein the tile size and loop order combinations in the table provide the plurality of predetermined tile size and loop order combinations, wherein each of the plurality of ARF values may be computed based on the respective sample locality aware rulebook.

Example 24 includes the method of Example 23, wherein each respective tile size and loop order combination is determined based on minimizing the number of data accesses required for the compute engine to process an unstructured sparse data set.

Example 25 includes the method of any of Examples 20-24, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set, wherein the sparsity attributes encode local sparsity structure in form of memory-size requirements and data-accesses over a range of region-sizes in the respective sample unstructured sparse data set, and wherein tile size includes a number of rulebook lines per tile and the loop order includes one of an input-stationary walk pattern, an output-stationary walk pattern, or a weight-stationary walk pattern.

Example 26 includes an apparatus comprising means for performing the method of any of Examples 20-24.

Thus, technology described herein improves the performance of computing systems through data acceleration and optimization techniques providing faster, more efficient and more accurate processing of 3D pointcloud data. For example, the technology may achieve up to 90% savings in data accesses, 3× improvements in compute utilization (low runtimes, lower latency) compared to CPU implementations, improvements that are consistent across datasets (with varying sparsity) over several architecture configurations (memory, compute-size/bandwidth ratios). The technology includes an improved rulebook metadata structure that encapsulates all neighborhood voxels in a receptive filed or response field and is more compressed than other rulebooks used in CPU/GPU implementations, requiring approximately half of the memory of other rulebooks, while maintaining approximately the same creation time and overhead compared to such rulebooks. The sparsity-aware optimal dataflow outperforms current non-tile-based implementation with significantly lower data-accesses.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system, comprising:
a processor;
a memory coupled to the processor to store instructions which, when executed by the processor, cause the processor to:
generate a locality-aware rulebook based on an input unstructured sparse data set, the locality-aware rulebook storing spatial neighborhood information for active voxels in the input unstructured sparse data set;
determine, from a plurality of predetermined tile size and loop order combinations, a tile size and loop order combination for processing the unstructured sparse data set based on an average receptive field (ARF) value, the ARF value computed based on the locality-aware rulebook, wherein the plurality of predetermined tile size and loop order combinations have been derived based on data sparsity attributes; and
process by a compute engine the unstructured sparse data set via tile-based execution using the locality-aware rulebook and the tile size and loop order combination.

2. The system of claim 1, wherein each line of the locality aware rulebook comprises one of:
an index of an input voxel representing an offset address for the input voxel data, a bitmask indicating active output voxels in an output response field of the input voxel and bit-locations of convolution weights to be applied, and indices of output voxels in the output response field; or
an index of an output voxel representing an offset address for the output voxel data, a bitmask indicating active input voxels in an input receptive field of the output voxel and bit-locations of convolution weights to be applied, and indices of input voxels in the input receptive field.

3. The system of claim 1, wherein the instructions, when executed, further cause the processor to:
generate, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set;
generate, for each sample locality-aware rulebook, a set of sparsity attributes representing data sparsity within the respective sample unstructured sparse data set, the sparsity attributes computed over a range of a number of rulebook lines per tile;
generate a set of meta-sparsity attributes based on the sets of sparsity attributes, the meta-sparsity attributes representing a data sparsity quality for the plurality of sample unstructured sparse data sets; and
determine, for each of a plurality of average receptive field (ARF) values, a tile size and loop order combination for processing, by the compute engine, unstructured sparse data based on the set of meta-sparsity attributes and on network and architecture configuration parameters.

4. The system of claim 3, wherein the instructions, when executed, further cause the processor to:
generate a table including a plurality of tile size and loop order combinations based on each respective determined tile size and loop order combination and the respective ARF value, wherein the tile size and loop order combinations in the table provide the plurality of predetermined tile size and loop order combinations;
wherein each of the plurality of ARF values may be computed based on the respective sample locality aware rulebook.

5. The system of claim 4, wherein each respective tile size and loop order combination is determined based on minimizing the number of data accesses required for the compute engine to process an unstructured sparse data set.

6. The system of claim 5, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set,
wherein the sparsity attributes encode local sparsity structure in form of memory-size requirements and data-accesses over a range of region-sizes in the respective sample unstructured sparse data set, and
wherein tile size includes a number of rulebook lines per tile and the loop order includes one of an input-stationary walk pattern, an output-stationary walk pattern, or a weight-stationary walk pattern.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
generate a locality-aware rulebook based on an input unstructured sparse data set, the locality-aware rulebook storing spatial neighborhood information for active voxels in the input unstructured sparse data set;
compute an average receptive field (ARF) value based on the locality aware rulebook; and
determine, from a plurality of predetermined tile size and loop order combinations, a tile size and loop order combination for processing the unstructured sparse data based on the computed ARF value, wherein the plurality of predetermined tile size and loop order combinations have been derived based on data sparsity attributes;
wherein the locality-aware rulebook and the tile size and loop order combination are to be provided to a compute engine, the compute engine to process the unstructured sparse using the locality aware rulebook and the tile size and loop order combination.

8. The apparatus of claim 7, wherein each line of the locality aware rulebook comprises one of:
an index of an input voxel representing an offset address for the input voxel data, a bitmask indicating active output voxels in an output response field of the input voxel and bit-locations of convolution weights to be applied, and indices of output voxels in the output response field; or
an index of an output voxel representing an offset address for the output voxel data, a bitmask indicating active input voxels in an input receptive field of the output voxel and bit-locations of convolution weights to be applied, and indices of input voxels in the input receptive field.

9. The apparatus of claim 7, wherein the logic is further to:
generate, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set;
generate, for each sample locality-aware rulebook, a set of sparsity attributes representing data sparsity within the respective sample unstructured sparse data set, the sparsity attributes computed over a range of a number of rulebook lines per tile;
generate a set of meta-sparsity attributes based on the sets of sparsity attributes, the meta-sparsity attributes representing a data sparsity quality for the plurality of sample unstructured sparse data sets; and
determine, for each of a plurality of average receptive field (ARF) values, a tile size and loop order combination for processing, by the compute engine, unstructured sparse data based on the set of meta-sparsity attributes and on network and architecture configuration parameters.

10. The apparatus of claim 9, wherein the logic is further to:
generate a table including a plurality of tile size and loop order combinations based on each respective determined tile size and loop order combination and the respective ARF value, wherein the tile size and loop order combinations in the table provide the plurality of predetermined tile size and loop order combinations;
wherein each of the plurality of ARF values may be computed based on the respective sample locality aware rulebook.

11. The apparatus of claim 10, wherein each respective tile size and loop order combination is determined based on minimizing the number of data accesses required for the compute engine to process an unstructured sparse data set.

12. The apparatus of claim 11, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set,
wherein the sparsity attributes encode local sparsity structure in form of memory-size requirements and data-accesses over a range of region-sizes in the respective sample unstructured sparse data set, and
wherein tile size includes a number of rulebook lines per tile and the loop order includes one of an input-stationary walk pattern, an output-stationary walk pattern, or a weight-stationary walk pattern.

13. The apparatus of claim 7, wherein the logic coupled to the one or more substrates includes transistor channel regions that are positioned within the one or more substrates.

14. At least one non-transitory computer readable storage medium comprising a set of instructions which, when executed by a computing system, cause the computing system to:
generate a locality-aware rulebook based on an input unstructured sparse data set, the locality-aware rulebook storing spatial neighborhood information for active voxels in the input unstructured sparse data set;
compute an average receptive field (ARF) value based on the locality aware rulebook; and
determine, from a plurality of predetermined tile size and loop order combinations, a tile size and loop order combination for processing the unstructured sparse data based on the computed ARF value, wherein the plurality of predetermined tile size and loop order combinations have been derived based on data sparsity attributes;
wherein the locality-aware rulebook and the tile size and loop order combination are to be provided to a compute engine, the compute engine to process the unstructured sparse data using the locality aware rulebook and the tile size and loop order combination.

15. The at least one non-transitory computer readable storage medium of claim 14, wherein each line of the locality aware rulebook comprises one of:
an index of an input voxel representing an offset address for the input voxel data, a bitmask indicating active output voxels in an output response field of the input voxel and bit-locations of convolution weights to be applied, and indices of output voxels in the output response field; or
an index of an output voxel representing an offset address for the output voxel data, a bitmask indicating active input voxels in an input receptive field of the output voxel and bit-locations of convolution weights to be applied, and indices of input voxels in the input receptive field.

16. The at least one non-transitory computer readable storage medium of claim 14, wherein the instructions, when executed, further cause the computing system to:
generate, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set;
generate, for each sample locality-aware rulebook, a set of sparsity attributes representing data sparsity within the respective sample unstructured sparse data set, the sparsity attributes computed over a range of a number of rulebook lines per tile;
generate a set of meta-sparsity attributes based on the sets of sparsity attributes, the meta-sparsity attributes representing a data sparsity quality for the plurality of sample unstructured sparse data sets; and
determine, for each of a plurality of average receptive field (ARF) values, a tile size and loop order combination for processing, by the compute engine, unstructured sparse data based on the set of meta-sparsity attributes and on network and architecture configuration parameters.

17. The at least one non-transitory computer readable storage medium of claim 16, wherein the instructions, when executed, further cause the computing system to:
generate a table including a plurality of tile size and loop order combinations based on each respective determined tile size and loop order combination and the respective ARF value, wherein the tile size and loop order combinations in the table provide the plurality of predetermined tile size and loop order combinations;
wherein each of the plurality of ARF values may be computed based on the respective sample locality aware rulebook.

18. The at least one non-transitory computer readable storage medium of claim 17, wherein each respective tile size and loop order combination is determined based on minimizing the number of data accesses required for the compute engine to process an unstructured sparse data set.

19. The at least one non-transitory computer readable storage medium of claim 18, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set,
wherein the sparsity attributes encode local sparsity structure in form of memory-size requirements and data-accesses over a range of region-sizes in the respective sample unstructured sparse data set, and
wherein tile size includes a number of rulebook lines per tile and the loop order includes one of an input-stationary walk pattern, an output-stationary walk pattern, or a weight-stationary walk pattern.

20. A method of optimizing sparse data processing, comprising:
generating a locality-aware rulebook based on an input unstructured sparse data set, the locality-aware rulebook storing spatial neighborhood information for active voxels in the input unstructured sparse data set;
computing an average receptive field (ARF) value based on the locality aware rulebook; and
determining, from a plurality of predetermined tile size and loop order combinations, a tile size and loop order combination for processing the unstructured sparse data based on the computed ARF value, wherein the plurality of predetermined tile size and loop order combinations have been derived based on data sparsity attributes;
wherein the locality-aware rulebook and the tile size and loop order combination are provided to a compute engine, the compute engine to process the unstructured sparse data using the locality aware rulebook and the tile size and loop order combination.

21. The method of claim 20, wherein each line of the locality aware rulebook comprises one of:
an index of an input voxel representing an offset address for the input voxel data, a bitmask indicating active output voxels in an output response field of the input voxel and bit-locations of convolution weights to be applied, and indices of output voxels in the output response field; or
an index of an output voxel representing an offset address for the output voxel data, a bitmask indicating active input voxels in an input receptive field of the output voxel and bit-locations of convolution weights to be applied, and indices of input voxels in the input receptive field.

22. The method of claim 20, further comprising:
generating, for each of a plurality of sample unstructured sparse data sets, a sample locality-aware rulebook based on the respective sample unstructured sparse data set, each sample locality-aware rulebook storing spatial neighborhood information for active voxels in the respective sample unstructured sparse data set;
generating, for each sample locality-aware rulebook, a set of sparsity attributes representing data sparsity within the respective sample unstructured sparse data set, the sparsity attributes computed over a range of a number of rulebook lines per tile;
generating a set of meta-sparsity attributes based on the sets of sparsity attributes, the meta-sparsity attributes representing a data sparsity quality for the plurality of sample unstructured sparse data sets; and
determining, for each of a plurality of average receptive field (ARF) values, a tile size and loop order combination for processing, by the compute engine, unstructured sparse data based on the set of meta-sparsity attributes and on network and architecture configuration parameters.

23. The method of claim 22, further comprising:
generating a table including a plurality of tile size and loop order combinations based on each respective determined tile size and loop order combination and the respective ARF value, wherein the tile size and loop order combinations in the table provide the plurality of predetermined tile size and loop order combinations;
wherein each of the plurality of ARF values may be computed based on the respective sample locality aware rulebook.

24. The method of claim 23, wherein each respective tile size and loop order combination is determined based on minimizing the number of data accesses required for the compute engine to process an unstructured sparse data set.

25. The method of claim 24, wherein each of the sample unstructured sparse data sets is a three-dimensional (3D) pointcloud data set, wherein the input unstructured sparse data set is a 3D pointcloud data set, wherein the locality-aware rulebook and each sample locality-aware rulebook is generated from a one-dimensional (1D) compressed data set that includes the coordinates of active voxels in the respective unstructured sparse data set,
wherein the sparsity attributes encode local sparsity structure in form of memory-size requirements and data-accesses over a range of region-sizes in the respective sample unstructured sparse data set, and
wherein tile size includes a number of rulebook lines per tile and the loop order includes one of an input-stationary walk pattern, an output-stationary walk pattern, or a weight-stationary walk pattern.
